(19) United States
(12) Patent Application Publication
(10) Pub. No.: US 2013/0262013 A1
(43) Pub. Date: Oct. 3, 2013

(54) INFORMATION PROCESSING DEVICE, INFORMATION PROCESSING METHOD, AND PROGRAM

(71) Applicant: SONY CORPORATION, Tokyo (JP)

(72) Inventor: Naoki Ide, Tokyo (JP)

(73) Assignee: Sony Corporation, Tokyo (JP)

(21) Appl. No.: 13/780,036

(22) Filed: Feb. 28, 2013

(30) Foreign Application Priority Data
Mar. 28, 2012 (JP) 2012-073504

(51) Int. Cl. G06F 17/18

(52) U.S. Cl. CPC G06F 17/18
USPC 702/104; 702/108

(57) ABSTRACT

An information processing device includes a sensor that measures predetermined data, a model storage unit that stores a model obtained by modeling time series data measured in the past, an information amount computation unit that computes an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and a measurement control unit that controls the sensor based on the information amount obtained from the measurement.

### BACKGROUND

The present technology relates to an information processing device, an information processing method, and a program, and particularly to an information processing device, an information processing method, and a program which can control sensors to perform measurement with high efficiency without unnecessary measurements.

In the related art, there is a method of controlling a plurality of sensors which is configured not to perform communication with a network in a sensor node on a sensor network for collecting information detected by the plurality of sensors if spatial and temporal prediction is possible (for example, refer to Japanese Unexamined Patent Application Publication No. 2007-80190).

Various kinds of sensors are mounted on a mobile device such as smartphone so as to facilitate use thereof. Applications which provide suitable services to users using data obtained by such mounted sensors have been developed.

### SUMMARY

However, if sensors are operated at all times in general use, the following inconvenience occurs.

If the number of measurement times is high, even though power consumed by a sensor per measurement time is low, consumption power increases after all, and a battery (rechargeable battery) thereby runs out fast, which causes inconvenience for a user. As such an example, a GPS (Global Positioning System) sensor, or the like, mounted in mobile devices such as smartphone is exemplified. Note that such an example in which the number of measurement times is desired to be lowered is not limited to consumption power. Sensors that may inflict harm on human bodies through measurement desirably attain lowering the number of measurement times.

In addition, there are cases in which a measurement is not able to be performed even though measurement is intended according to the type of sensors. For example, in the example of a GPS sensor mentioned above, there are cases in which performing measurement is difficult in indoor places, between buildings, inside tunnels, and the like. In addition, even if measurement is possible, there are cases in which satisfactory accuracy is not obtained at 11 times, and performing measurement in such a case shows low efficiency.

Further, when data that was measured in the past using sensors is accumulated, there are cases in which it is not necessary to perform measurement again due to similar data to that previously acquired, and performing measurement in such a case also shows low efficiency. In an example of a GPS sensor, when a user does not move his or her position, measurement data has substantially the same value, and thus repetitive measurement means low efficiency.

It is desirable for the present technology to control a sensor to perform measurement with high efficiency without performing unnecessary measurement.

According to an embodiment of the present technology, there is provided an information processing device that includes a sensor that measures predetermined data, a model storage unit that stores a model obtained by modeling time series data measured in the past, an information amount computation unit that computes an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and a measurement control unit that controls the sensor based on the information amount obtained from the measurement.

According to another embodiment of the present technology, there is provided an information processing method of an information processing device that includes a sensor that measures predetermined data and a model storage unit that stores a model obtained by modeling time series data measured in the past, the method including steps of computing an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and controlling the sensor based on the information amount obtained from the measurement.

According to still another embodiment of the present technology, there is provided a program for causing a computer device that includes a sensor that measures predetermined data and a model storage unit that stores a model obtained by modeling time series data measured in the past to execute processes of computing an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and controlling the sensor based on the information amount obtained from the measurement.

According to the embodiments of the present technology, the information amount obtained from measurement is computed based on the difference of an information amount when measurement by a sensor is not performed which is decided based on a prior distribution of state variables of a model obtained by modeling time series data measured in the past and an information amount when measurement by the sensor is performed which is decided based on a posterior distribution of the state variables of the model, and the sensor is controlled based on the information amount obtained from the measurement.

Note that the program may be provided by being transmitted through a transmission medium, or recorded on a recording medium.

The information processing device may be an independent device, or an internal block constituting one device.

According to the embodiments of the present technology, it is possible to control the sensor so as to perform measurement with high efficiency without performing unnecessary measurement.

### BRIEF DESCRIPTION OF THE DRAWINGS

FIG. 1 is a block diagram showing a configuration example of a first embodiment of a measurement system to which the present technology is applied;

FIG. 2 is a block diagram showing a configuration example when the measurement system of FIG. 1 is realized as a computer;

FIG. 3 is a block diagram showing a configuration example of hardware of the computer that realizes the measurement system of FIG. 1;

FIG. 4 is a diagram showing an example of time series data;

FIG. 5 is a diagram showing state transition of a Hidden Markov Model;

FIG. 6 is a diagram showing an example of a transition table of the Hidden Markov Model;

FIG. 7 is a diagram showing an example of a state table in which observation probabilities of the Hidden Markov Model are stored;

FIGS. 8A and 8B are diagrams showing examples of state tables in which observation probabilities of the Hidden Markov Model are stored;

FIG. 9 is a diagram showing a graphical model showing the relationship between time series data and the Hidden Markov Model;

FIG. 10 is a trellis diagram describing predictive calculation by a measurement information amount computation unit;

FIG. 11 is a diagram describing a process at a time of data missing;

FIG. 12 is a conceptual diagram describing a process of the measurement information amount computation unit;

FIG. 13 is a diagram describing an approximate calculation method of the difference ΔH of information entropies;

FIG. 14 is a diagram showing an example of a variable conversion table;

FIG. 15 is a flowchart describing a sensing control process;

FIG. 16 is a trellis diagram describing a process for predicting up to a predetermined step;

FIG. 17 is a flowchart describing a sensing control process for predicting up to the predetermined step;

FIG. 18 is a flowchart describing a data restoration process;

FIG. 19 is a diagram showing a example of a state table when a case in which measurement is failed is considered;

FIG. 20 is a diagram describing an embodiment in which a case of being an unknown state is considered;

FIG. 21 is a diagram describing an embodiment in which a case of being an unknown state is considered;

FIG. 22 is a diagram describing an application example of an application that uses a GPS sensor;

FIGS. 23A and 23B are diagrams describing an application example of an application that uses a GPS sensor;

FIG. 24 is a diagram describing an application example of an application that uses a GPS sensor;

FIG. 25 is a diagram describing an application example of an application that uses a GPS sensor;

FIG. 26 is a diagram describing an application example of an application that uses a GPS sensor;

FIG. 27 is a diagram describing an application example of an application that uses a GPS sensor;

FIG. 28 is a diagram describing an application example of an application that uses a GPS sensor; and

FIG. 29 is a diagram describing an application example of an application that uses a GPS sensor.

### DETAILED DESCRIPTION OF EMBODIMENTS

Hereinafter, preferred embodiments (hereinafter, referred to as embodiments) for implementing the present technology will be described. Note that description will be provided in the following order.

1. First Embodiment (A Basic Embodiment)

2. Second Embodiment (An Embodiment Considering Failure of Measurement)

3. Third Embodiment (An Embodiment Considering Being an Unknown State)

4. Fourth Embodiment (An Embodiment Using Database)

5. Application Example of Application

### 1. First Embodiment

### Configuration Example of Measurement System

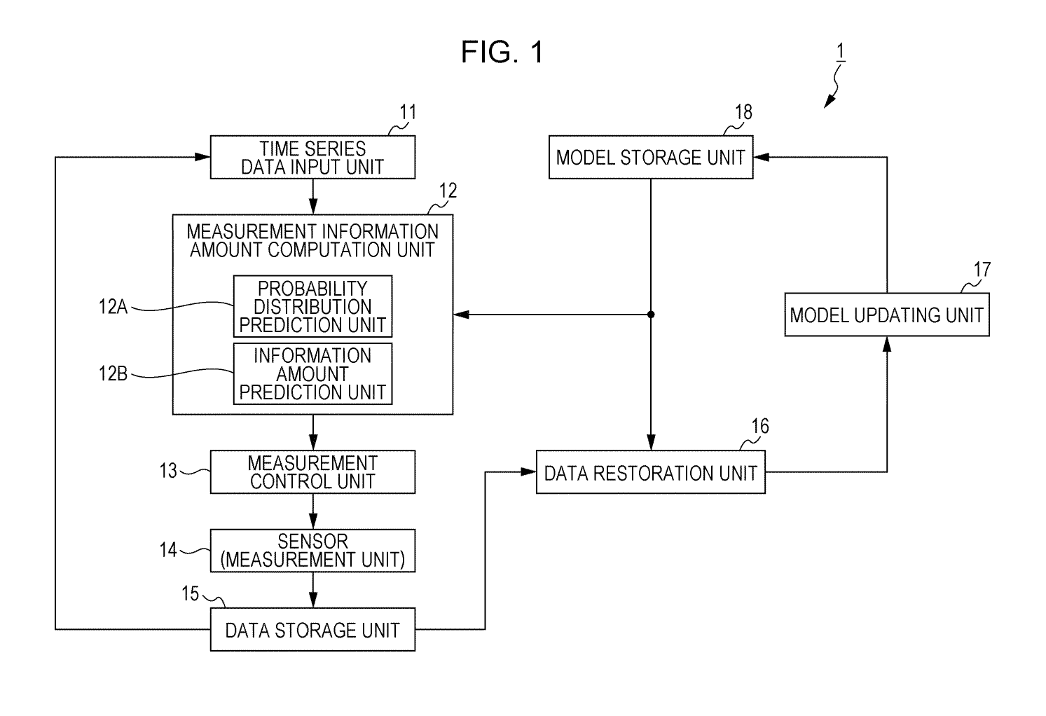

FIG. 1 shows a configuration example of a first embodiment of a measurement system to which the present technology is applied.

The measurement system 1 shown in FIG. 1 is configured to include a time series data input unit 11, a measurement information amount computation unit 12, a measurement control unit 13, a sensor (measurement unit) 14, a data storage unit 15, a data restoration unit 16, a model updating unit 17, and a model storage unit 18.

The time series data input unit 11 is time series data measured by the sensor 14, acquires time series data accumulated for a predetermined time from the data storage unit 15 up to the previous measurement, and inputs the data to the measurement information amount computation unit 12.

The measurement information amount computation unit 12 measures information amount obtained from the next measurement of the sensor 14. The measurement information amount computation unit 12 can be largely classified into a probability distribution prediction unit 12A that predicts probability distribution of data and an information amount prediction unit 12B that predicts information amount obtained in measurement based on predicted probability distribution in terms of the functions.

More specifically, the measurement information amount computation unit 12 calculates the difference (information entropy difference) between an information amount (information entropy) of the next measurement and an information amount (information entropy) when measurement is not performed using a learning model supplied from the model storage unit 18 and time series data supplied from the time series data input unit 11.

Then, the measurement information amount computation unit 12 decides whether or not the next measurement by the sensor 14 is to be performed based on the calculated difference of the information amounts, and then supplies the decided result to the measurement control unit 13. In other words, when the difference between the information amount when measurement is performed subsequently and the information amount when measurement is not performed is large, in other words, when the information amount obtained from the subsequent measurement is large, the measurement information amount computation unit 12 decides to operate the sensor 14. On the other hand, when an information amount is small even though the sensor 14 is operated, the measurement information amount computation unit 12 decides not to operate the sensor 14. Note that, in the present embodiment, as a learning model in which time series data that was obtained in the past and is stored in the model storage unit 18, a Hidden Markov Model will be employed as will be described later.

When the measurement information amount computation unit 12 decides to operate the sensor 14, the measurement control unit 13 controls the sensor 14 to perform measurement.

The sensor 14 functions as a measurement unit that measures predetermined data, and executes or pauses measurement according to control of the measurement control unit 13. For example, the sensor 14 is a GPS sensor, or the like that is mounted on a mobile device such as a smartphone to acquire current positions (latitude and longitude).

The data storage unit 15 is a buffer that temporarily stores data supplied from the sensor 14. In the data storage unit 15, data measured by the sensor 14 at a short time interval such as an interval of one second, or one minute is stored for a predetermined accumulation period such as for one day or one week that is longer than the measurement interval. Then, after a given accumulation period elapses, the accumulated time series data is supplied to the data restoration unit 16. In addition, the time series data accumulated in the data storage unit 15 is also supplied to the time series data input unit 11 at a predetermined timing.

Note that, as in a case in which a GPS sensor performs measurement inside a tunnel, there are cases in which data is not able to be acquired depending on the state of measurement, and some pieces of the time series data accumulated in the data storage unit 15 are missed.

When some pieces of the time series data accumulated for a given period are missed, the data restoration unit 16 applies the Viterbi algorithm to the time series data so as to execute a data restoration process in which missing data pieces are stored. The Viterbi algorithm is an algorithm for estimating a most likely state series based on given time series data and the Hidden Markov Model.

In addition, the model updating unit 17 updates parameters of the learning model stored in the model storage unit 18 using the time series data of which missing pieces are restored by the data restoration unit 16. Note that, in updating the learning model, the time series data before data restoration in which the missing pieces are included may be used without change.

The model storage unit 18 stores parameters of the learning model in which temporal transition of the sensor 14 is learned using time series data that was obtained by the sensor 14 in the past. In the present embodiment, the Hidden Markov Model (HMM) is employed as the learning model, and parameters of the Hidden Markov Model are stored in the model storage unit 18.

Note that the learning model in which the time series data that was obtained by the sensor 14 in the past is not limited to the Hidden Markov Model, and other learning model, for example, a regression model which predicts probability distribution of future data based on an accumulated time-series database may also be employed. In addition, the model storage unit 18 may employ a method in which the time series data that was obtained by the sensor 14 in the past is stored as a database so as to be directly used without change. The method in which the time series data of the past is stored in the model storage unit 18 as a database without change so as to be used will be described later as a third embodiment.

The parameters of the learning model stored in the model storage unit 18 are updated by the model updating unit 17 using time series data newly accumulated in the data restoration unit 16. In other words, data is added to the learning model stored in the model storage unit 18, or the database is extended.

In the measurement system 1 configured as above, the difference between the information amount when measurement is performed by the sensor 14 and the information amount when measurement is not performed in the sensor 14 is calculated based on the time series data obtained by the sensor 14 up to the previous measurement. Then, the information amount obtained from measurement by the sensor 14 is determined to be large, the sensor 14 is controlled to be operated. Accordingly, the sensor can be controlled so as to perform measurement with high efficiency without performing unnecessary measurement.

### Configuration Example in Realization Using a Computer

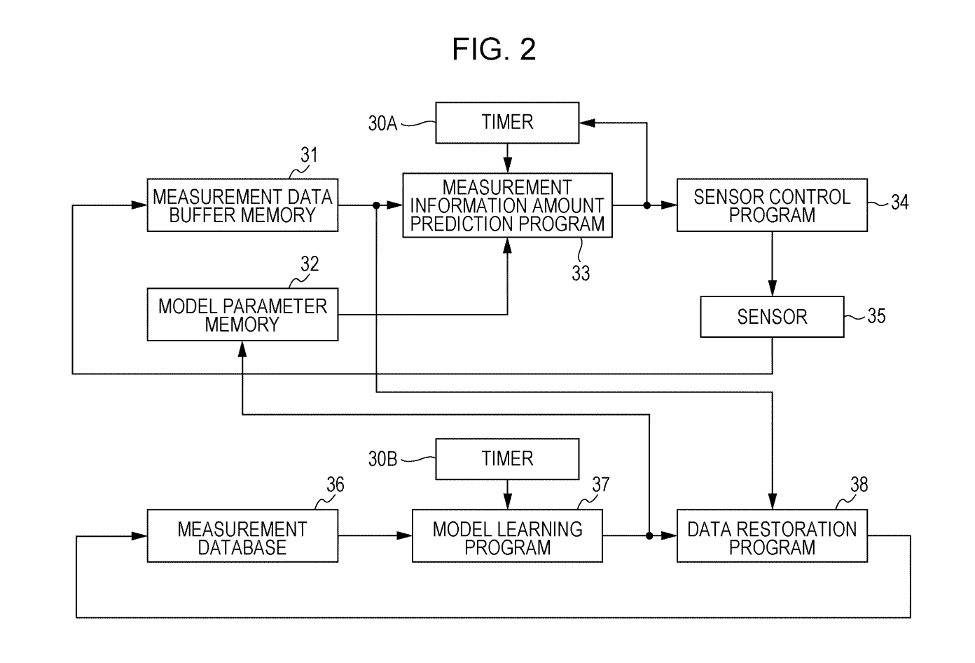

FIG. 2 is a block diagram showing a configuration example when the measurement system 1 of FIG. 1 is realized by causing a computer to execute a predetermined program.

When the measurement system 1 of FIG. 1 is realized as a computer, a measurement information amount prediction program 33, a sensor control program 34, a model learning program 37, and a data restoration program 38 are prepared as programs executed in a computer as shown in FIG. 2. In addition, as a storage unit in which predetermined data is stored, a measurement data buffer memory 31, a model parameter memory 32, and a measurement database 36 are prepared.

The measurement data buffer memory 31 is a memory in which data output by a sensor 35 is temporarily stored. Every time measurement is performed by the sensor 35 and then data is output, the output data is additionally stored in the measurement data buffer memory 31.

The model parameter memory 32 stores parameters when modeling to a predetermined learning model is performed by the model learning program 37 based on time series data of the past accumulated in the measurement database 36. Herein, as a learning model stored in the model parameter memory 32, for example, the Hidden Markov Model (HMM), or the like is considered. Note that time series data of the past acquired up to that time may be stored in the model parameter memory 32 as a database without change.

The measurement information amount prediction program 33 acquires model parameters of the learning model (the Hidden Markov Model) acquired from the model parameter memory 32 and the time series data stored in the measurement data buffer memory 31 so as to compute an information amount obtained from measurement by the sensor 35. Then, the measurement information amount prediction program 33 decides whether or not the sensor 35 is to be operated based on the computed information amount, and when performing operation is decided, the intent is instructed to the sensor control program. In addition, the measurement information amount prediction program 33 sets an elapsed time to the next operation determination timing at which whether or not the sensor 35 is to be operated is determined in a timer 30A.

The timer 30A counts the elapsed time designated by the measurement information amount prediction program 33, and when the designated elapsed time passes, notifies the measurement information amount prediction program 33 of being at the operation determination timing.

The sensor control program 34 controls operation levels of the sensor 35. In the present embodiment, as operation levels of the sensor 35, there are assumed to be two levels of on and off in the most simple manner, and accordingly, the sensor control program 34 controls the sensor 35 to be on or off. Note that, when there are a plurality of operation levels such as high, intermediate, and low as the operation levels of the sensor 35, for example, the measurement information amount prediction program 33 decides one of the plurality of operation levels based on computed information amount, and then the sensor control program 34 controls so that an operation is performed at the operation level decided by the measurement information amount prediction program 33. In addition, the sensor control program 34 may control a continuous signal output level, signal accuracy, or the like, rather than the divided operation levels as high, intermediate, and low.

The operation of the sensor 35 is controlled by the sensor control program 34, and when the function of the sensor 35 is executed, measured data is output to the measurement data buffer memory 31.

The measurement database 36 stores time series data of the past measured by the sensor 35 that serves as learning data that is modeled using a predetermined learning model.

The model learning program 37 performs learning to obtain parameters when the time series data for learning stored in the measurement database 36 as a database is modeled using the predetermined learning model according to the timing instructed by the timer 30B. In the present embodiment, the Hidden Markov Model is employed as a learning model to learn the time series data obtained in the past, but other learning model can also be employed. Details of the Hidden Markov Model will be described later. The model parameters learned (updated) by the model learning program 37 are supplied to the model parameter memory 32 and the data restoration program 38.

The timer 30B counts the time to the performance of the next parameter updating by the model learning program 37 by the model learning program 37 performing updating of the parameters of the learning model at an interval of a given time. Then, when it is time to perform the updating of the parameters, the timer 30B notifies the model learning program 37 of the fact. Note that the time interval in which the timer 30B notifies that it is time to perform the updating of the parameters is longer than the time interval in which the timer 30A notifies that it is time to perform the operation determination. Accordingly, the updating of the parameters of the learning model is executed at a time when time series data of a given amount (for a given period) is accumulated in the measurement data buffer memory 31.

The data restoration program 38 restores a data portion which the sensor 35 is not able to measure and in which data is missing out of the time series data stored in the measurement data buffer memory 31 using the model parameters learned (updated) by the model learning program 37. The data restoration program 38 is, for example, a program to execute the Viterbi algorithm, and interpolates a data missing portion using likelihood data estimated in the Hidden Markov Model. Note that the entire time series data can also be configured to be generated by switching a portion thereof in which the sensor 35 performs measurement into likelihood data estimated in the Hidden Markov Model. The data restoration program 38 is useful when a data missing portion is complemented, or an acquisition interval of data, which is not uniform, is corrected so as to be uniform.

As above, the measurement system 1 of FIG. 1 can be realized as a computer by causing a CPU (Central Processing Unit) to execute data measurement in a plurality of divided programs in a parallel manner, and causing the memory (storage unit) to store measured data and the parameters of the learning model.

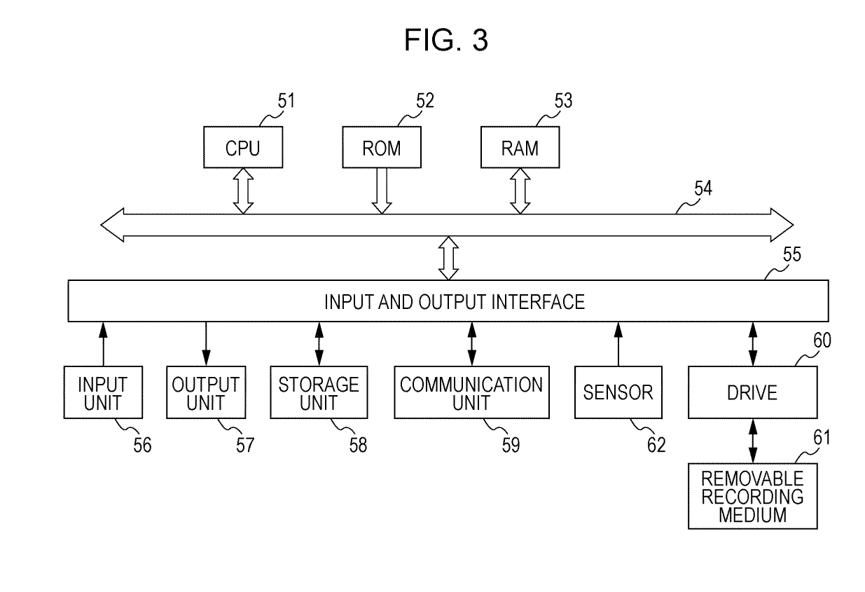

FIG. 3 is a block diagram showing a configuration example of hardware of the computer that realizes the measurement system 1 of FIG. 1.

In the computer, the CPU (Central Processing Unit) 51, a ROM (Read Only Memory) 52, and a RAM (Random Access Memory) 53 are connected to one another via a bus 54.

Further, an input and output interface 55 is connected to the bus 54. To the input and output interface 55, an input unit 56, an output unit 57, a storage unit 58, a communication unit 59, and a drive 60 are connected.

The input unit 56 includes a keyboard, a mouse, a microphone, or the like. The output unit 57 includes a display, a speaker, or the like. The storage unit 58 includes a hard disk, a non-volatile memory, or the like. The communication unit 59 includes a communication module that communicates with other communication devices or base stations through the Internet, a mobile telephone network, a wireless LAN, a satellite broadcasting network, or the like. A sensor 62 is a sensor corresponding to the sensor 14 of FIG. 1 or the sensor 35 of FIG. 2. The drive 60 drives a removable recording medium 61 such as a magnetic disk, an optical disc, a magneto-optical disc, or a semiconductor memory.

In the computer configured as above, the CPU 51 causes programs stored in, for example, the storage unit 58 to be loaded on the RAM 53 so as to be executed via the input and output interface 55 and the bus 54. Herein, the programs loaded on the RAM 53 and then executed include the measurement information amount prediction program 33, the sensor control program 34, the model learning program 37, and the data restoration program 38 in terms of the example of FIG. 2. In addition, the measurement data buffer memory 31 and the model parameter memory 32 of FIG. 2 correspond to the RAM 53 of FIG. 3, and the measurement database 36 of FIG. 2 corresponds to the storage unit 58 of FIG. 3.

In the computer, the various programs such as the measurement information amount prediction program 33 can be installed in the storage unit 58 using the input and output interface 55 by loading the removable recording medium 61 on the drive 60. In addition, the programs can be received in the communication unit 59 via a wired or wireless transmission medium such as a local area network, the Internet, or a digital satellite broadcasting so as to be installed in the storage unit 58. Alternatively, the programs can be installed in the ROM 52 or the storage unit 58 in advance.

Hereinafter, details of each unit of the measurement system 1 will be described. Hereinbelow, description will be provided using the configurations of the functional block diagrams of the measurement system 1 shown in FIG. 1. Example of Time Series Data

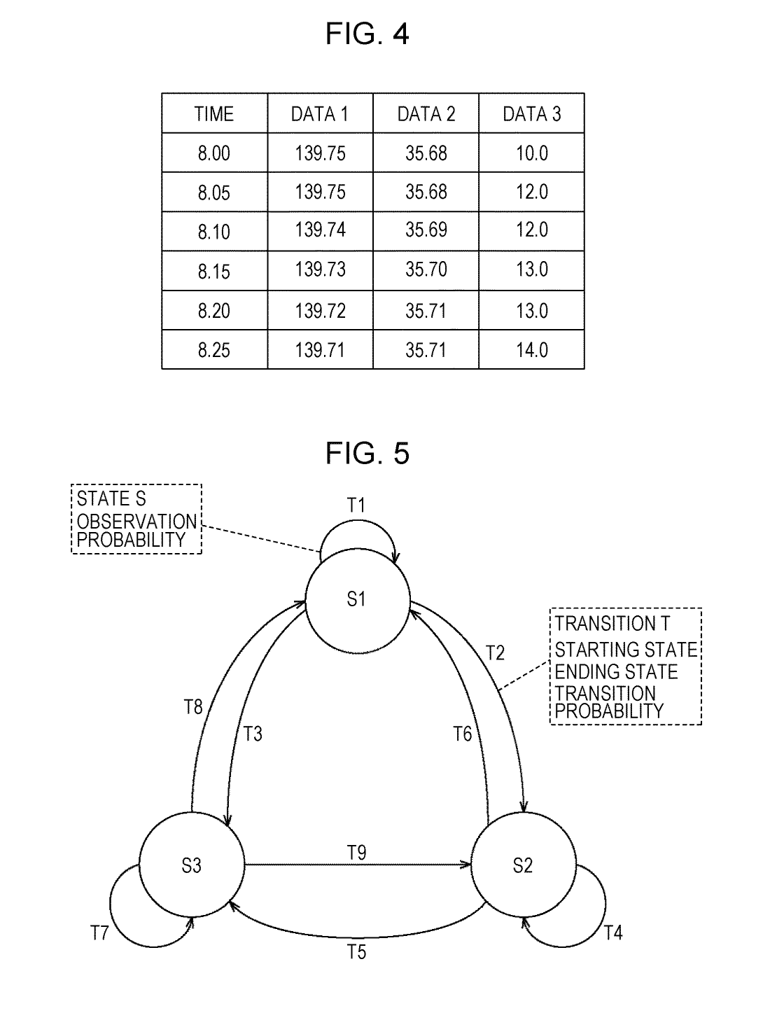

FIG. 4 shows an example of time series data obtained by the sensor 14.

The time series data of FIG. 4 is data including three types of data pieces (data 1, data 2, and data 3) arranged in a time series manner, and times at which the data pieces are obtained. The type and number of data pieces, a time interval at which the data pieces are acquired (a step width of times), and the like differ depending on the type of the sensor 14. In addition, time intervals at which the data pieces are obtained are not necessarily to be uniform intervals. Note that, when the time intervals at which the data pieces are obtained are uniform intervals, the field of times may be omitted or numbers that indicate order of steps, or the like may be stored instead of times. Each of the plurality of data pieces other than the times can be expressed by a discrete symbol, a continuous quantity, or a combination thereof. In addition, the number of dimensions of the plurality of data pieces other than the times is not necessarily to be one dimension, but may be two or higher dimensions.

As the simplest method of measuring time series data, there is a method in which measurement is continuously performed at given time intervals that are decided in advance. However, with regard to an interval at which measure data is acquired, there are cases in which measuring at short time intervals is desirable, or pausing measurement for a long period of time causes no problem, depending on the cases. In the measurement system 1, time series data is learned using the Hidden Markov Model (learning model), and a measurement time interval can be adaptively changed according to the state of the learning model.

### Hidden Markov Model

With reference to FIGS. 5 to 9, the Hidden Markov Model in which the time series data obtained by the sensor 14 is modeled will be described.

FIG. 5 shows state transition of the Hidden Markov Model.

The Hidden Markov Model is a probability model to model time series data using a transition probability and an observation probability of a state in hidden layers. Details of the Hidden Markov Model are described in, for example, “Algorithm for Pattern Recognition and Learning” written by Yoshinori Uesaka and Kazuhiko Ozeki, Bun-ichi Sogo Shuppan, and “Pattern Recognition and Machine Learning” written by C. M. Bishop, Springer Japan, and the like.

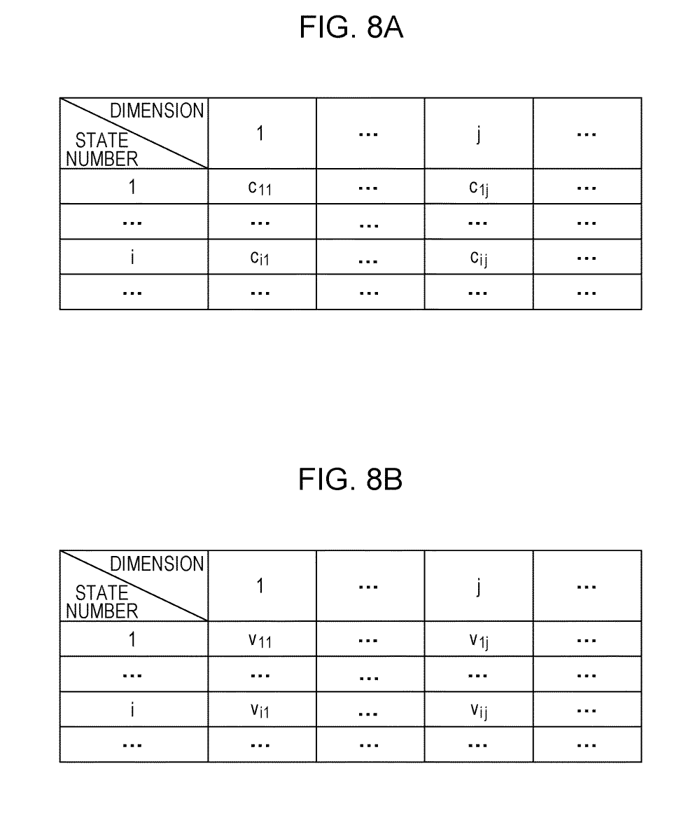

FIG. 5 shows three states of a state S1, a state S2, and a state S3, and nine transitions T of transition T1 to T9. Each of the transitions T is defined by three parameters of a starting state indicating the state before a transition, an ending state indicating the state after a transition, and a transition probability indicating a probability in which a state is transitioned from a starting state to an ending state. In addition, each state has an observation probability indicating a probability that each symbol is taken as a parameter based on which discrete symbol of which data is decided in advance will be taken. Thus, such parameters are stored in the model storage unit 18 in which the Hidden Markov Model is stored as a learning model in which the time series data obtained by the sensor 14 in the past is learned. Parameters of a state differ according to a configuration of data, in other words, whether a data space (observation space) is a discrete space or a continuous space as will be described later with reference to FIGS. 7, 8A, and 8B.

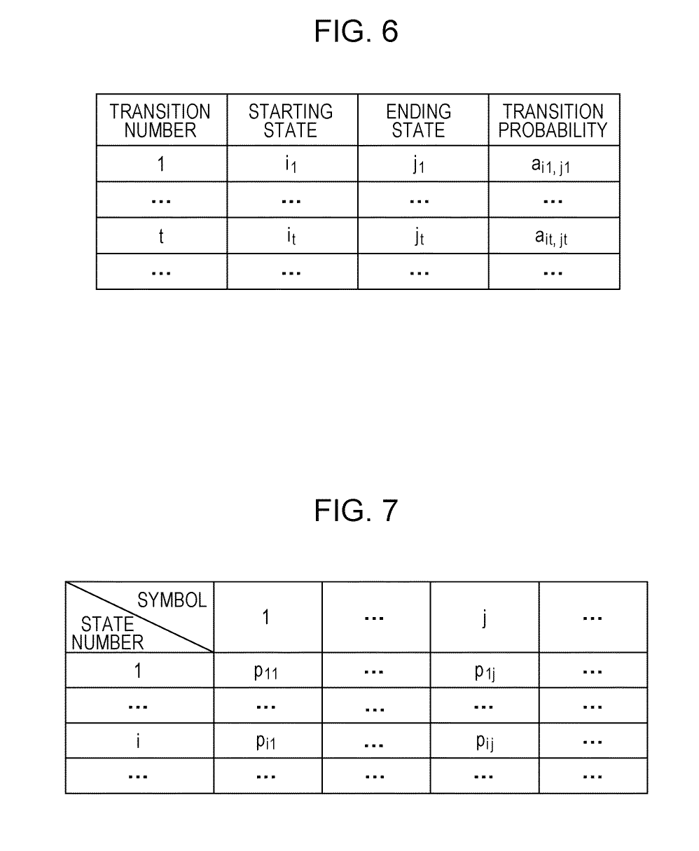

FIG. 6 shows an example of a transition table in which parameters of a starting state, an ending state, and a transition probability of each transition t of the Hidden Markov Model are stored.

The transition table shown in FIG. 6 stores starting states, ending states, transition probabilities per transition t in the state in which transition numbers (serial numbers) for identifying each transition t are given thereto. For example, a t-th transition indicates a transition from a state iₜ to a state jₜ, and the probability thereof (transition probability) is aᵢₜⱼₜ. Note that a transition probability is standardized for transitions having the same starting state.

FIGS. 7, 8A, and 8B show examples of state tables in which observation probabilities which are parameters of a state S are stored.

FIG. 7 shows an example of a state table in which observation probabilities of each state are stored when a data space (observation space) is a discrete space, in other words, when data takes any one of discrete symbols.

In the state table shown in FIG. 7, probabilities that each symbol is taken are stored for state numbers given to each state of the Hidden Markov Model in a predetermined order. There are N states of S1, . . . , Si, . . . , and SN, and symbols that can be taken in the data space are 1, . . . , j, . . . , and K. In this case, for example, the probability that a symbol j is taken in an i-th state Si is pᵢⱼ. However, this probability pᵢⱼ is standardized for the same state Si.

FIGS. 8A and 8B show an example of a state table in which observation probabilities of each state when a data space (observation space) is a continuous space, in other words, when data takes continuous symbols and further follows a normal distribution that is decided in advance for each state are stored.

When data takes continuous symbols and follows a normal distribution decided in advance for each state, center values and variance values of the normal distribution that typify the normal distribution of each state are stored as a state table.

FIG. 8A is a state table in which the center values of the normal distribution of each state are stored, and FIG. 8B is a state table in which the variance values of the normal distribution of each state are stored. In the examples of FIGS. 8A and 8B, there are N states of S1, . . . , Si, . . . , and SN, and the number of dimensions of the data space is 1, . . . , j, . . . and D.

According to the state tables shown in FIGS. 8A and 8B, j-dimensional components of data obtained in, for example, i-th state Si are obtained in a distribution following the normal distribution of a center value cᵢⱼ and a variance value vᵢⱼ.

In the model storage unit 18 in which the parameters of the Hidden Markov Model are stored, one transition table shown in FIG. 6 and a state table corresponding to data (sensor data) obtained by the sensor 14 are stored. The state table corresponding to the sensor data is stored in the model storage unit 18 in the form of FIG. 7 when the data space of the sensor data is a discrete space, and in the form of FIGS. 8A and 8B when the data space of the sensor data is a continuous space.

When the sensor data is GPS data obtained by a GPS sensor, for example, the sensor data is continuous data that takes the values of real numbers not the values of integers, and thus, a state table of the sensor data is stored in the model storage unit 18 in the form of the state table for continuous symbols shown in FIGS. 8A and 8B.

In this case, the state table of the sensor data becomes a table obtained in such a way that a user who holds a mobile device on which a GPS sensor is mounted discretizes positions where he or she frequently goes or passes as states and the center value and variance values of each of the discretized states are stored therein.

Thus, a parameter cᵢⱼ the state table of the GPS data indicates the center value of a position corresponding to a state Si out of states obtained by discretized positions where the user frequently passes. A parameter vᵢⱼ in the state table of the GPS data indicates a variance value of a position corresponding to the state Si.

Note that, since the GPS data is configured to include two types of data pieces of latitude and longitude, the dimension number of the GPS data can be considered to be 2 by setting j=1 to be the latitude (x axis) and j=2 to be the longitude (y axis). Note that the dimension number of the GPS data may be 3 by incorporating time information into the GPS data.

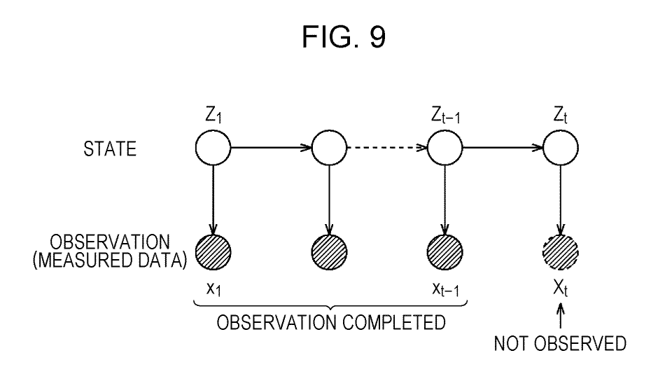

FIG. 9 shows a graphical model showing the relationship between time series data obtained by the sensor 14 and the Hidden Markov Model as a learning model in which the data is learned.

The graphical model of the Hidden Markov Model is a model in which a state Zₜ of a time (step) t is probabilistically determined using a state Zₜ₋₁ of a time t−1 (a Markov property), and an observation Xₜ of the time t is probabilistically determined using only the state Zₜ.

In FIG. 9, the lowercase x indicates data that has been measured and the uppercase X indicates data that has not been measured. Thus, in FIG. 9, data pieces x₁, x₂, . . . , and xₜ₋₁ from a time 1 to time t−1 indicates data pieces that have been measured, and the data piece at the time t indicates data not measured.

The measured data pieces x₁, x₂, . . . , and xₜ₋₁ from the time 1 to the time t−1 shown in FIG. 9 are input to the measurement information amount computation unit 12 from the data storage unit 15 by the time series data input unit 11. The measurement information amount computation unit 12 determines whether or not a data piece Xₜ of the time t is to be acquired by operating the sensor 14 using the Hidden Markov Model.

The probability distribution prediction unit 12A of the measurement information amount computation unit 12 predicts a probability distribution P(Zₜ) of a state Zₜ at the time t for each case in which the sensor data Xₜ of the time t is not measured and in which the data is measured. The information amount prediction unit 12B calculates the information entropy difference using the probability distribution P(Zₜ) of each case in which the sensor data Xₜ of the time t is not measured and in which the data is measured.

### Probability Distribution Prediction Unit 12A

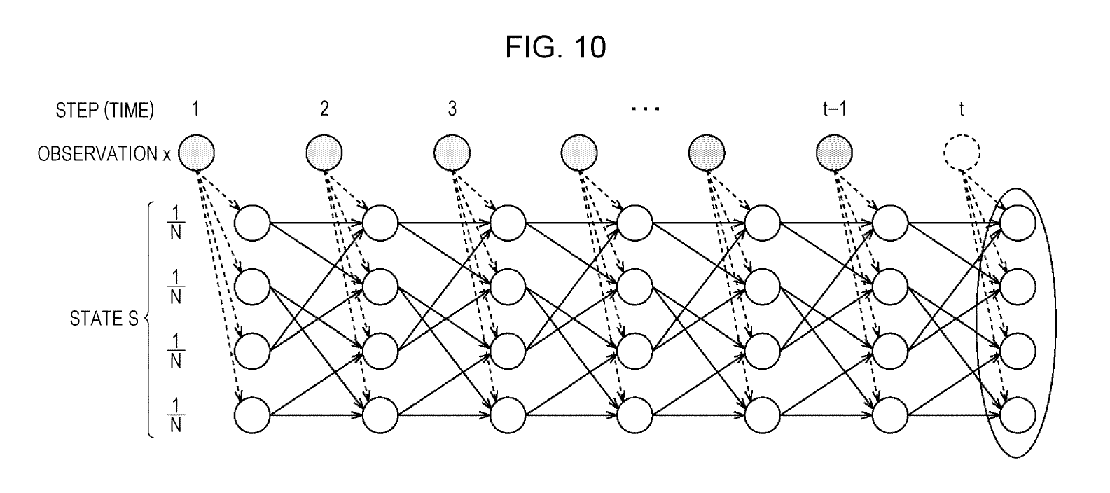

FIG. 10 is a trellis diagram describing predictive calculation of the probability distribution P(Zₜ) of the state Zₜ at the time t by the probability distribution prediction unit 12A.

In FIG. 10, the white circles indicate states of the Hidden Markov Model, and four states are prepared in advance. The gray circles indicate observations (measured data). A step (time) t=1 indicates an initial state, and state transitions that can be implemented in each step (time) are shown by solid-lined arrows.

The probability distribution P(Z₁) of each state in the step t=1 of the initial state is given as an equal probability as in, for example, Formula (1).

P(Z₁)=1/N (1)

In Formula (1), Z₁ is the ID of the state (internal state) in the step t=1, and hereinafter, a state in a step t of ID=Zₜ is referred to simply as a state Zₜ. The N of Formula (1) indicates the number of states of the Hidden Markov Model.

Note that, when an initial probability π(Z₁) of each state is given, P(Z₁)=π(Z₁) can be satisfied using the initial probability π(Z₁). In most cases, the initial probability is held as a parameter in the Hidden Markov model.

The probability distribution P(Zₜ) of the state Zₜ in the step t is given in a recurrence formula using a probability distribution P(Zₜ₋₁) of a state Zₜ₋₁ in a step t−1. Then, the probability distribution P(Zₜ₋₁) of the state Zₜ₋₁ in the step t−1 can be indicated by a conditional probability when a measured data piece x_{1:t-1} from the step 1 to the step t−1 is known. In other words, the probability distribution P(Zₜ₋₁) of the state Zₜ₋₁ in the step t−1 can be expressed by Formula (2).

P(Zₜ₋₁)=P(Zₜ₋₁|x_{1:t-1})(Zₜ₋₁=1, . . . , and n) (2)

In Formula (2), x_{1:t-1} indicates known measured data x from the step 1 to the step t−1. The right side of Formula (2) is more precisely P(Zₜ₋₁|X_{1:t-1}=x_{1:t-1}).

In the state Zₜ in the step t, a probability distribution (prior probability) before measurement P(Zₜ)=P(Zₜ|x_{1:t-1}) is obtained by updating the probability distribution P(Zₜ₋₁) of the state Zₜ₋₁ in the step t−1 using a transition probability P(Zₜ|Zₜ₋₁)=aᵢⱼ. In other words, the probability distribution (prior probability) when measurement by the sensor 14 is not performed, which is P(Zₜ)=P(Zₜ|x_{1:t-1}) can be expressed by Formula (3). Note that the above-described transition probability aᵢⱼ is a parameter held in the transition table of FIG. 6.

$$P ( {Z}_{t} ) = P ( {Z}_{t} \vert {x}_{1 : t - 1} ) = {\sum }_{{Z}_{t - 1} = 1}^{N} P ( {Z}_{t} \vert {Z}_{t - 1} ) P ( {Z}_{t - 1} ) \qquad ( 3 )$$

Formula (3) indicates a process in which the probabilities of all state transitions up to the state Zₜ in the step t are added together.

Note that, instead of Formula (3), the following Formula (3′) can also be used.

P(Zₜ)=max_{Z}_{_{t−1}}(P(Zₜ|Zₜ₋₁)P(Zₜ₋₁))/Ω (3′)

Herein, Ω is a standardized constant of a probability of Formula (3′). Formula (3′) is used when it is important to select only transitions with the highest occurrence probability out of state transitions in each step than to select an absolute value of a probability, for example, when a state transition series with the highest occurrence probability such as the Viterbi algorithm is desired to know.

On the other hand, if an observation Xₜ is obtained from measurement, a probability distribution P(Zₜ|Xₜ) of a conditional probability (posterior probability) of the state Zₜ under the condition in which the observation Xₜ is obtained can be acquired. In other words, the posterior probability P(Zₜ|Xₜ) from measurement of the observation Xₜ can be expressed as follows.

$$P ( {Z}_{t} \vert {X}_{t} ) = \frac{P ( {X}_{t} \vert {Z}_{t} ) P ( {Z}_{t} )}{{\sum }_{{Z}_{t} = 1}^{N} P ( {X}_{t} \vert {Z}_{t} ) P ( {Z}_{t} )} \qquad ( 4 )$$

Wherein, the observation Xₜ in an uppercase in the step t is data that has not been measured, and indicates a probability variable.

As shown in Formula (4), the posterior probability P(Zₜ|Xₜ) from the measurement of the observation Xₜ can expressed using a likelihood P(Xₜ|Zₜ) of the state Zₜ generating the observation Xₜ and the prior probability P(Zₜ) based on Bayes' theorem. Herein, the prior probability P(Zₜ) is known by the recurrence formula of Formula (3). In addition, the likelihood P(Xₜ|Zₜ) of the state Zₜ generating the observation Xₜ is a parameter p_{xt,zt} of the state table of the Hidden Markov Model of FIG. 7 if the observation Xₜ is a discrete variable.

In addition, if the observation Xₜ is a continuous variable and components of each dimension j are modeled when following the normal distribution of the center of μᵢⱼ=cᵢⱼ, and a variance of σᵢⱼ²=vᵢⱼ that are decided in advance for each state i=Zₜ, the likelihood is as follows.

$$P ( {X}_{t} \vert {Z}_{t} ) = {\prod }_{j = 1}^{D} N ( {X}_{t} \vert {μ}_{ij} , {σ}_{ij}^{2} ) \qquad [ Math . 5 ]$$

Wherein, cᵢⱼ and vᵢⱼ that are used as parameters of the center and variance are parameters of the state table shown in FIGS. 8A and 8B.

Thus, if a probability variable Xₜ is found (if the probability variable Xₜ becomes a normal variable xₜ from measurement), Formula (4) can be easily calculated, and a posterior probability on the condition in which time series data up to the observation Xₜ is obtained can be calculated.

A formula of updating a probability in the Hidden Markov Model is expressed by an updating rule of Formula (4) in which the data xₜ at a current time t is known. In other words, the formula of updating the probability in the Hidden Markov Model is expressed by a formula in which the observation Xₜ of Formula (4) is replaced by the data xₜ. However, the measurement information amount computation unit 12 desires to acquire a probability distribution of a state before measurement at the current time t is performed. In such a case, a formula in which P(Xₜ|Zₜ) of the updating rule in Formula (4) is set to “1” can be used. In other words, the formula in which P(Xₜ|Zₜ) of Formula (4) is set to “1” is Formula (3) or (3′), and corresponds to the prior probability P(Zₜ) before measurement by the sensor 14 at the time t is performed.

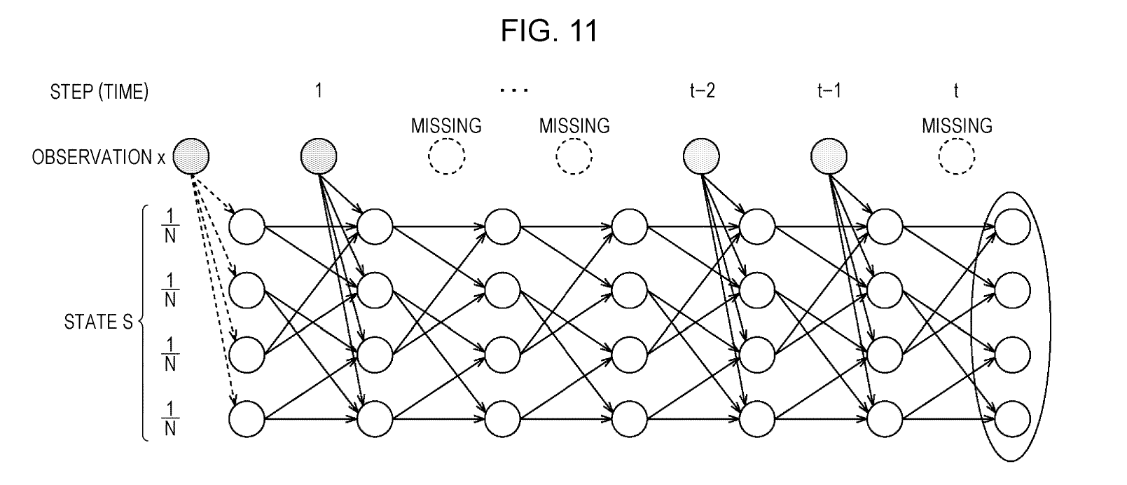

In addition, as shown in FIG. 11, the above can be applied in the same manner also to a case in which data missing occurs in time series data of the past from the time 1 prior to the current time to the time t−1. In other words, when data missing is shown in the time series data, P(X|Z) of the data missing portion in the updating formula of Formula (4) can be substituted by “1” for calculation (since the time of the data missing portion is not specified, subscripts of P(X|Z) are omitted).

### Information Amount Prediction Unit 12B

The information amount prediction unit 12B decides to operate the sensor 14 when an information amount obtained from measurement by the sensor 14 is large. In other words, the information amount prediction unit 12B decides to operate the sensor 14 by performing measurement of the sensor 14 when ambiguity when measurement is not performed can be reduced. This ambiguity is ambiguity in a probability distribution, ad can be expressed by an information entropy that the probability distribution has.

An information entropy H(Z) is expressed by the following Formula (5) in general.

H(Z)=−∫dZP(Z)log P(Z)=−ΣP(Z)log P(Z) (5)

If the interval variable (Z) of the information entropy H(Z) is continuous, it can be expressed with an integral sign in the entire space of Z and if the interval variable Z is discrete, it can be expressed with an addition sign for all Zs.

In order to calculate the difference of information amounts when measurement by the sensor 14 is performed and not performed, first, each information amount when measurement by the sensor 14 is performed and when measurement by the sensor 14 is not performed is considered.

The prior probability P(Zₜ) when measurement by the sensor 14 is not performed can be expressed by Formula (3) or (3′). Thus, an information entropy H_{b} when measurement by the sensor 14 is not performed can be expressed by Formula (6) using Formula (3).

$$\begin{matrix}{H}_{b} = H ( {Z}_{t} ) \\ = - {\sum }_{{Z}_{t} = 1}^{N} P ( {Z}_{t} \vert {x}_{t} ) log P ( {Z}_{t} \vert {x}_{t} ) \\ = - {\sum }_{{Z}_{t} = 1}^{N} P ( {Z}_{t} ) log P ( {Z}_{t} )\end{matrix} \qquad ( 6 )$$

The information amount when measurement by the sensor 14 is not performed is an information amount computed from a posterior probability P(Zₜ₋₁|xₜ₋₁) of a state variable obtained from the time series data up to the previous measurement and a prior probability P(Zₜ|xₜ) of a state variable at a current time that is predicted from a transition probability of the Hidden Markov Model.

On the other hand, the posterior probability P(Zₜ|Xₜ) when measurement by the sensor 14 is performed can be expressed by Formula (4), but since the observation Xₜ has not been measured yet in reality, it is a probability variable. Thus, it is necessary to acquire an information entropy Hₐ when measurement by the sensor 14 is performed under the condition of the distribution of the probability variable Xₜ. In other words, the information entropy Hₐ when measurement by the sensor 14 is performed can be expressed by Formula (7).

$$\begin{matrix}{H}_{a} = {E}_{{X}_{t}} [ H ( {Z}_{t} ) ] \\ = H ( {Z}_{t} \vert {X}_{t} ) \\ = - \int d {X}_{t} P ( {X}_{t} ) {\sum }_{{Z}_{t} = 1}^{N} P ( {Z}_{t} \vert {x}_{t} , {X}_{t} ) log P ( {Z}_{t} \vert {x}_{t} {X}_{t} ) \\ = - \int d {X}_{t} {\sum }_{{Z}_{t} = 1}^{N} P ( {X}_{t} \vert {Z}_{t} ) P ( {Z}_{t} ) log \frac{P ( {X}_{t} \vert {Z}_{t} ) P ( {Z}_{t} )}{{\sum }_{{Z}_{t}^{′} = 1}^{N} P ( {X}_{t} \vert {Z}_{t}^{′} ) P ( {Z}_{t}^{′} )}\end{matrix} \qquad ( 7 )$$

The formula in the first line of Formula (7) shows that an information entropy of a posterior probability under the condition in which the observation Xₜ is obtained is acquired as an expected value of the probability variable Xₜ. However, since the formula is equal to a definitional formula of a conditional information entropy with respect to the state Zₜ under the condition in which the observation Xₜ is obtained, it can be expressed as the formula in the second line. The formula in the third line is one obtained by developing the formula in the second line according to Formula (5), and the formula in the fourth line is one obtained by being developed according to Formula (4).

The information amount when measurement by the sensor 14 is performed is an information amount obtained in such a way that data obtained from the measurement is expressed using the observation variable Xₜ, and an information amount that can be computed from the posterior probability P(Zₜ|Xₜ) of the state Zₜ in the Hidden Markov Model under the condition in which the observation variable Xₜ is obtained is obtained by calculating an expected value of the observation variable Xₜ.

As above, the difference ΔH of information entropies when measurement by the sensor 14 is performed and not performed can be expressed as follows using Formulas (6) and (7).

$$\begin{matrix}Δ H = {H}_{a} - {H}_{b} \\ = H ( {Z}_{t} \vert {X}_{t} ) - H ( {Z}_{t} ) \\ = - I ( {Z}_{t} ; {X}_{t} ) \\ = - \int d {X}_{t} {\sum }_{{Z}_{t} = 1}^{N} P ( {X}_{t} \vert {Z}_{t} ) P ( {Z}_{t} ) log \frac{P ( {X}_{t} \vert {Z}_{t} ) P ( {Z}_{t} )}{{\sum }_{{Z}_{t}^{′} = 1}^{N} P ( {X}_{t} \vert {Z}_{t}^{′} ) P ( {Z}_{t}^{′} )} + \\ {\sum }_{{Z}_{t} = 1}^{N} P ( {Z}_{t} ) log P ( {Z}_{t} ) \\ = - \int d {X}_{t} {\sum }_{{Z}_{t} = 1}^{N} P ( {X}_{t} \vert {Z}_{t} ) P ( {Z}_{t} ) log \frac{P ( {X}_{t} \vert {Z}_{t} )}{{\sum }_{{Z}_{t}^{′} = 1}^{N} P ( {X}_{t} \vert {Z}_{t}^{′} ) P ( {Z}_{t}^{′} )}\end{matrix} \qquad ( 8 )$$

The formula in the second line of Formula (8) shows that the difference ΔH of the information entropies is obtained by multiplying a mutual information amount I(Zₜ;Xₜ) of the state Zₜ and the observation Xₜ in the Hidden Markov Model by −1. The formula in the third line of Formula (8) is a formula obtained by being substituted by Formulas (6) and (7) described above, and the formula in the fourth line of Formula (8) is one obtained by arranging the formula in the third line. The difference ΔH of the information entropies is the amount of reduced ambiguity in the state variable, but the mutual information amount I obtained by multiplying −1 by the amount can be understood as an information amount necessary for resolving the ambiguity.

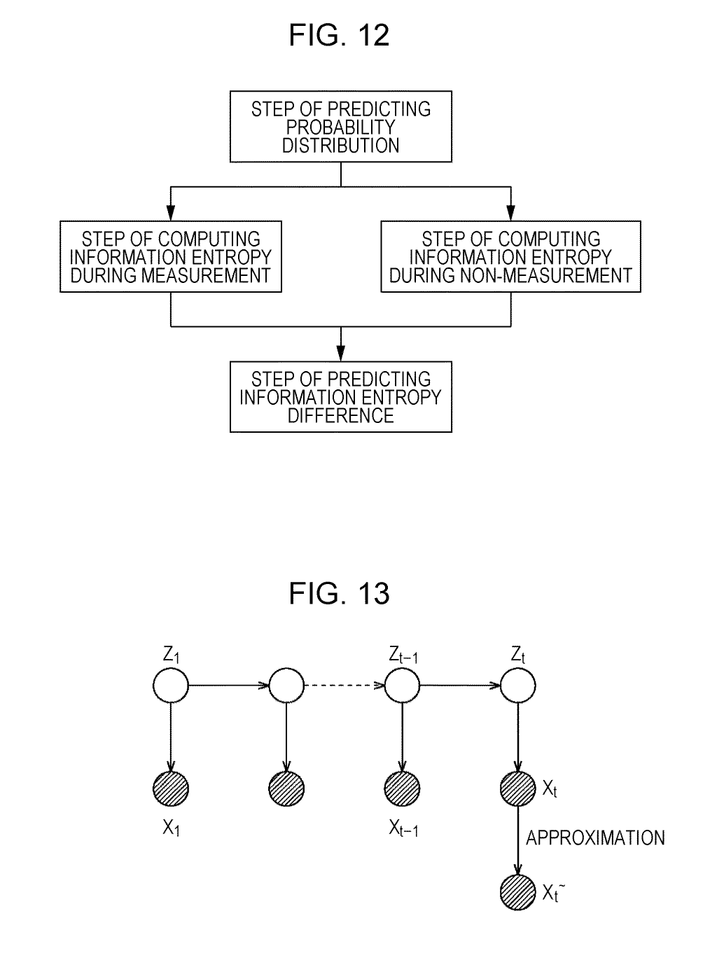

As described above, the probability distribution P(Zₜ) of the state Zₜ is predicted using Formulas (3) and (4) as a first step, information entropies when measurement is performed and not performed are computed using Formulas (6) and (7) as a second step, and finally, the difference ΔH of the information entropies is obtained in a sequential manner as shown in FIG. 12.

However, in order to determine whether or not the sensor 14 is to be operated, it is desirable to finally obtain the difference ΔH of the information entropies of Formula (8), and thus, the measurement information amount computation unit 12 is configured to directly compute the difference ΔH of the information entropies of Formula (8). Accordingly, a process to compute the difference ΔH of the information entropies can be easily performed.

### Approximate Calculation of the Difference ΔH of the Information Entropies

The calculation of the difference ΔH of the information entropies expressed in Formula (8) can be realized through enumeration if the observation Xₜ is a probability variable in a discrete data space. However, when the observation Xₜ is a probability variable in a continuous data space, it is necessary to fold an integration so as to obtain the difference ΔH of the information entropies. Since it is difficult for the integration in this case to analytically process a normal distribution having many peaks included in Formula (8), it has to be dependent on a numerical integration such as Monte Carlo integration, or the like. However, the difference ΔH of the information entropies is originally of an arithmetic operation in computation of an effect of measurement for reducing measurement costs, and it is not preferable that an arithmetic operation such as a numerical integration, or the like, having a high processing load be not included in the foregoing arithmetic operation. Therefore, in the computation of the difference ΔH of the information entropies of Formula (8), it is preferable to avoid a numerical integration.

Thus, hereinbelow, an approximate calculation method to avoid a numerical integration in the computation of the difference ΔH of the information entropies will be described.

In order to avoid taking costs to calculate Formula (8) due to the fact that the observation Xₜ is a continuous variable, an observation Xₜ^{˜} expressed as a discrete probability variable that is newly generated from the continuous probability variable Xₜ is introduced as shown in FIG. 13.

FIG. 13 is a diagram conceptually showing an approximation by the an observation Xₜ^{˜} expressed as a discrete probability variable that is newly generated from the continuous probability variable Xₜ.

If the discrete probability variable Xₜ^{˜} is used as above, Formula (8) can be modified into Formula (9).

$$Δ H ≅ Δ \tilde{H} ≡ - I ( {Z}_{t} ; {X}_{t}^{∼} ) = - {\sum }_{{X}_{t}^{∼}} {\sum }_{{Z}_{t} = 1}^{N} P ( {X}_{t}^{∼} \vert {Z}_{t} ) P ( {Z}_{t} ) log \frac{P ( {X}_{t}^{∼} \vert {Z}_{t} )}{{\sum }_{{Z}_{t}^{′} = 1}^{N} P ( {X}_{t}^{∼} \vert {Z}_{t}^{′} ) P ( {Z}_{t}^{′} )} \qquad ( 9 )$$

According to Formula (9), since the integration can be replaced by adding the entire elements up, integration calculation having a high processing load can be avoided.

However, since the continuous variable Xₜ is replaced by the discrete variable Xₜ^{˜} herein, reduction in an information amount can be easily imagined. In reality, the following inequality is generally satisfied between an information entropy obtained in Formula (8) and an information entropy obtained in Formula (9), the information entropies decrease to an approximate value.

I(Zₜ;Xₜ^{˜})≦I(Zₜ;Xₜ) (10)

Note that the sign of equality of Formula (10) is satisfied only when Xₜ=Xₜ^{˜}. Thus, the sign of equality is not satisfied when the continuous variable Xₜ is substituted by the discrete variable Xₜ^{˜}.

When the continuous variable Xₜ is substituted by the discrete variable Xₜ^{˜} (variable conversion), it is preferable to make Xₜ and Xₜ^{˜} correspond to each other as close as possible to reduce the difference between both sides of the inequality of Formula (10). Thus, in order to reduce the difference between both sides of the inequality of Formula (10), the discrete variable Xₜ^{˜} is defined as a discrete variable having the same symbol as the state variable Z. In other words, any method of substituting the continuous variable Xₜ with the discrete variable Xₜ^{˜} may be used, but efficient variable conversion can be performed by converting the variable into the state variable Z of the Hidden Markov Model in which time series data is efficiently learned.

With respect to the discrete variable Xₜ^{˜}, the probability of observing Xₜ^{˜} when X is given is given as follows.

$$P ( {X}^{∼} \vert X ) = \frac{P ( X \vert {X}^{∼} , λ )}{{\sum }_{{X}^{∼} = 1}^{N} P ( X \vert {X}^{∼} , λ )} \qquad ( 11 )$$

Herein, λ is a parameter for deciding a probability (probability density) in which an observation X is observed in a state Z. Based on the fact, Formula (11) can be expressed as follows.

$$\begin{matrix}P ( {X}^{∼} \vert Z ) = \frac{P ( {X}^{∼} , Z )}{P ( Z )} \\ = \int d X \frac{P ( {X}^{∼} , X , Z )}{P ( Z )} \\ = \int d XP ( {X}^{∼} \vert X ) P ( X \vert Z ) \\ = \int d X \frac{P ( X \vert {X}^{∼} ) P ( {X}^{∼} \vert Z )}{{\sum }_{{X}^{∼} = 1}^{N} P ( X \vert {X}^{∼} )}\end{matrix} \qquad ( 12 )$$

If the probability density to generate the observation X in the state Z is set to follow a normal distribution and the dimension of the observation X is set to D-dimension, data obtained from the state Z=i follows the normal distribution of the center value cᵢⱼ and the variance value vᵢⱼ for j-dimensional components, Formula (12) is written as follows.

$$P ( X = i \vert Z = j ) = {\prod }_{d = 1}^{D} {\int }_{- ∞}^{∞} d {X}_{d} \frac{N ( {X}_{d} \vert {c}_{id} , {v}_{id} ) N ( {X}_{d} \vert {c}_{jd} , {v}_{jd} )}{{\sum }_{j = 1}^{N} N ( {X}_{d} \vert {c}_{jd} , {v}_{jd} )} \qquad ( 13 )$$

Herein, N(x|c,v) is probability density of x of the normal distribution of the center c and the variance v shown in FIGS. 8A and 8B.

Formula (13) includes a normal distribution having many peaks in the denominator, and is difficult to be analytically obtained in general. Thus, in the same manner as when the difference ΔH of the information entropies of Formula (8) is calculated, it is necessary to obtain a numerical value using the Monte Carlo integration, or the like that use normally distributed random numbers.

However, it is not necessary to execute the calculation of Formula (13) every time before measurement is performed as when Formula (8) is obtained. Formula (13) may be calculated only once at the time of first construction of the Hidden Markov Model or model updating, and a table that retains the result is stored so as to be substituted for Formula (9) if necessary.

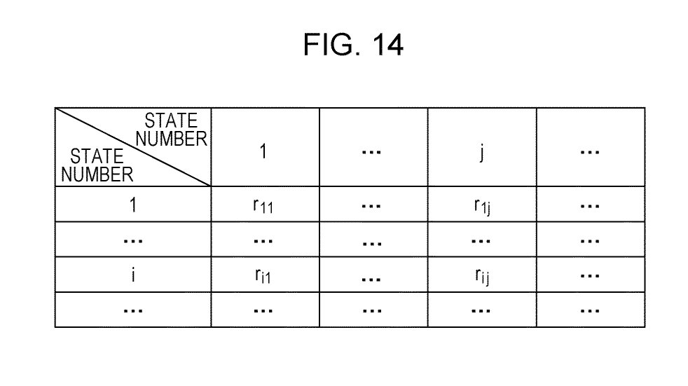

FIG. 14 shows an example of a variable conversion table that is a table in which observation probabilities of obtaining the discrete variable Xₜ^{˜} are retained for each state Z, as the calculation result of Formula (13).

A state number i of FIG. 14 corresponds to the state Z of Formula (13), and a state number j of FIG. 14 corresponds to the discrete variable Xₜ^{˜} of Formula (13). In other words, P(Xₜ^{˜}|Z) of Formula (13) is P(j|i) in FIG. 14, and P(j|i)=rᵢⱼ.

Note that, in the general Hidden Markov Model, such a variable conversion table is not necessary. Of course, if there is a room in calculation resources to the extent that Formula (8) can be calculated by numerical calculation, such a variable conversion table is not necessary. This variable conversion table is used when a strict approximation of Formula (8) to a certain degree is performed when there are calculation resources sufficient for executing numerical integration.

In addition, for an element rᵢⱼ in this variable conversion table, parameters of which the quantity is a square of the number of state are necessary. However, the element rᵢⱼ in this variable conversion table becomes 0 in most cases particularly in a mode in which there is little overlapping and hiding in a data space. Thus, in order to omit memory resources, various types of simplification are possible in such a way that only elements of a variable conversion table that are not 0 are stored, only super-ordinate elements having high values in each line are stored, all elements are made to be the same constant, or the like. The most audacious simplification is to set that rᵢⱼ=δᵢⱼ on the assumption that states i and j seldom occupy the same data space. δᵢⱼ is Kronecker delta, and becomes 1 when i=j, and 0 in other cases. In this case, Formula (9) is simplified without limit so as to be expressed as Formula (14).

$$Δ H ≅ Δ \tilde{H} ≡ - I ( {Z}_{t} ; {X}_{t}^{∼} ) = {\sum }_{{Z}_{t} = 1}^{N} P ( {Z}_{t} ) log P ( {Z}_{t} ) \qquad ( 14 )$$

Formula (14) means that a prediction entropy after measurement is 0, and an information amount that can be acquired through measurement only with a prediction entropy before measurement is estimated. In other words, Formula (14) assumes that the entropy after measurement becomes 0 since states are necessarily uniformly decided when measurement is performed by setting that rᵢⱼ=δᵢⱼ. In addition, with regard to Formula (14), if the ambiguity of data before measurement is high, the value of Formula (14) increases, and an information amount that can be acquired from measurement becomes large, but if the ambiguity of data before measurement is low, the value of Formula (14) decreases, which means that the ambiguity can be sufficiently resolved only from prediction without performing measurement.

### Flowchart of a Sensing Control Process

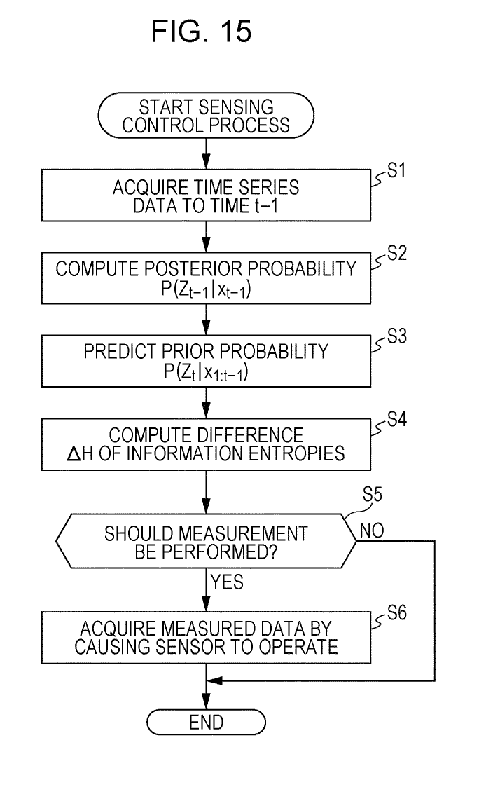

Next, with reference to the flowchart of FIG. 15, a sensing control process in which turning on and off of the sensor 14 are controlled by the measurement system 1 will be described. Note that it is assumed that parameters of the Hidden Markov Model as a learning model which are acquired from the model storage unit 18 are present in the measurement information amount computation unit 12 prior to this process.

In Step S1, first, the time series data input unit 11 acquires times series data that is measured up to the previous time t−1 of the current time t and then accumulated from the data storage unit 15, and then supplies the data to the measurement information amount computation unit 12.

In Step S2, the measurement information amount computation unit 12 computes a posterior probability P(Zₜ₋₁|xₜ₋₁) under the condition in which the data is obtained at the previous time t−1 of the current time t using Formula (4).

In Step S3, the measurement information amount computation unit 12 predicts a prior probability P(Zₜ)=P(Zₜ|x_{1:t-1}) before measurement at the current time t is performed by the sensor 14 using Formula (3).

In Step S4, the measurement information amount computation unit 12 calculates the difference ΔH of information entropies when measurement by the sensor 14 is performed and not performed using Formula (8). Alternatively, as Step S4, by performing calculation of Formula (9) or (14) using the variable conversion table of FIG. 14 which is approximate calculation of Formula (8), the measurement information amount computation unit 12 calculates the difference ΔH of the information entropies when measurement by the sensor 14 is performed and not performed.

In Step S5, by determining whether or not the calculated difference ΔH of the information entropies is lower than or equal to a predetermined threshold value I_{TH}, the measurement information amount computation unit 12 determines whether or not measurement by the sensor 14 should be performed at the time t.

When the difference ΔH of the information entropies is lower than or equal to the threshold value I_{TH}, and measurement by the sensor 14 is determined to be performed in Step S5, the process proceeds to Step S6, and the measurement information amount computation unit 12 determines to operate the sensor 14, and supplies the determination to the measurement control unit 13. The measurement control unit 13 controls the sensor 14 to operate so as to acquire measurement data from the sensor 14. The acquired measurement data is supplied to the data storage unit 15.

On the other hand, when the difference ΔH of the information entropies is greater than the threshold value I_{TH}, and measurement by the sensor 14 is determined not to be performed in Step S5, the process of Step S6 is skipped, and then the process ends.

The above process is executed at a given measurement interval of the sensor 14, for example, at an interval of one second, or the like.

In the above sensing control process, measurement by the sensor 14 can be performed only when an information amount obtained from measurement by the sensor 14 is large. In addition, when measurement by the sensor 14 is performed, measured data by the sensor 14 is used, and when measurement by the sensor 14 is not performed, data at the time t is estimated using the Hidden Markov Model that is a learning model based on time series data accumulated prior to the time t. Accordingly, the sensor 14 can be controlled so as to perform highly efficient measurement without performing unnecessary measurement.

Note that, in the above-described sensing control process, the threshold value I_{TH} used to determine whether or not the sensor 14 is to be operated may be a fixed value decided in advance, or may be a variation value that varies according to the current margin of an index used to decide measurement costs. If the measurement costs are assumed to correspond to consumption power of a battery, for example, a threshold value I_{TH}(R) changes according to a remaining amount R of the battery, and when the remaining amount of the battery is low, the threshold value I_{TH} may be changed according to the remaining amount so that the sensor 14 is not operated if an obtained information amount is not quite large. In addition, when the measurement costs correspond to a use rate of a CPU, the threshold value I_{TH} may be changed according to the use rate of the CPU, and when the use rate of the CPU is high, the sensor 14 can be controlled not to be operated if an obtained information amount is not quite large, or the like.

Note that as a method of controlling measurement by the sensor 14 to achieve highly efficient measurement, a method of lowering measurement accuracy of the sensor 14 is also considered. For example, a method of controlling the sensor 14 so as to change setting of a convergence time of approximate calculation that weakens intensity of measurement signals, or the like is considered. When control to change an operation level is performed in order to lower the measurement accuracy as above, it is desirable to perform the control so that the difference ΔH of information entropies measured according to the operation level after the change is smaller than at least 0.

### Sensing Control Process Up to a Predetermined Step

In the above-described sensing control process, whether or not measurement is to be performed is determined every time the time to measure comes. Next, a sensing control in which whether or not measurement is to be performed up to a predetermined step set in advance is determined, and sensing turns into a sleep mode until measurement is determined to be necessary.

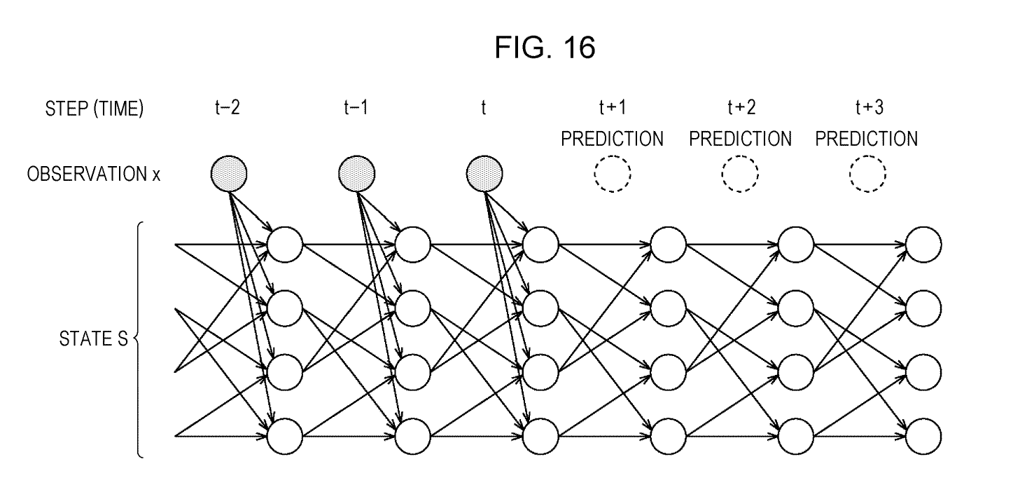

FIG. 16 is a trellis diagram describing a process to determine the necessity of measurement up to a predetermined step set in advance.

In a process in which necessity of measurement up to a predetermined step is determined, description will be provided by setting that the observation (measurement data) xₜ is obtained to the current time t, and the measurement information amount computation unit 12 determines necessity of measurement at future times t+1, t+2, . . . , as shown in FIG. 16.

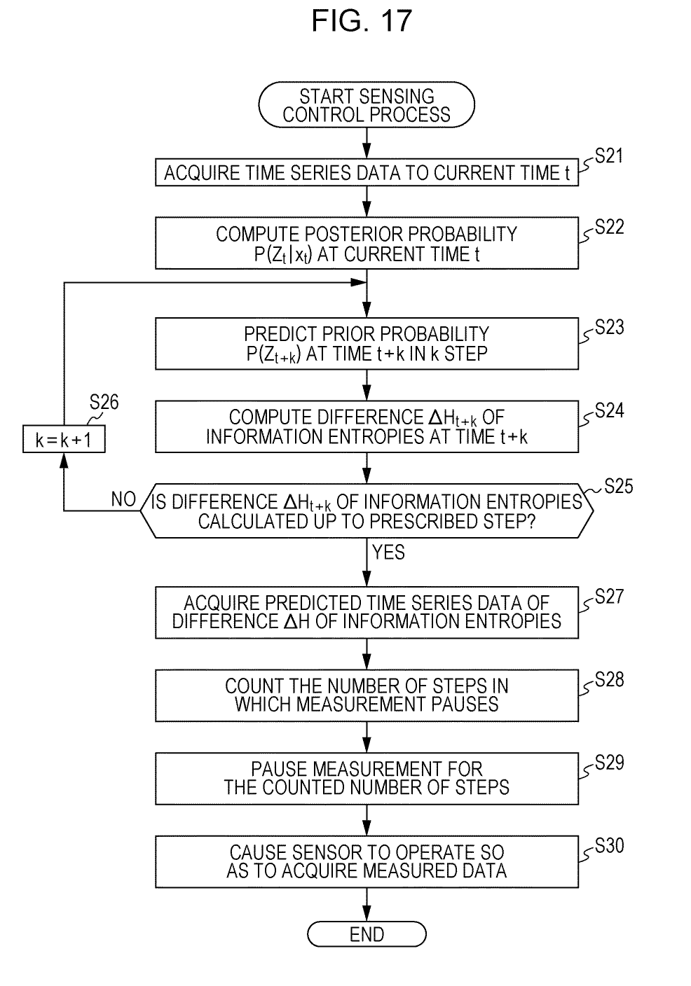

FIG. 17 is a flowchart describing a sensing control process in which necessity of measurement up to the predetermined step is determined.

First, in Step S21, the time series data input unit 11 acquires time series data to the current time t from the data storage unit 15, and supplies the data to the measurement information amount computation unit 12.

In Step S22, the measurement information amount computation unit 12 computes a posterior probability P(Zₜ|xₜ) of the condition in which data at the current time t is obtained using Formula (15). Since the observation (measurement data) xₜ is obtained at the current time t, the posterior probability P(Zₜ|xₜ) at the current time t is expressed in a formula in which the observation xₜ of Formula (4) is substituted by data xₜ. That is, the posterior probability P(Zₜ|xₜ) is expressed as follows.

$$P ( {Z}_{t} \vert {x}_{t} ) = \frac{P ( {x}_{t} \vert {Z}_{t} ) P ( {Z}_{t} )}{{\sum }_{{Z}_{t} = 1}^{N} P ( {x}_{t} \vert {Z}_{t} ) P ( {Z}_{t} )} \qquad ( 15 )$$

Then, in Step S23, the measurement information amount computation unit 12 predicts a prior probability p(Zₜ₊ₖ) at a future time t+k of a k-th step from the current time t using Formula (16).

$$P ( {Z}_{t + k} ) = P ( {Z}_{t + k} \vert {x}_{1 : t} ) = {\sum }_{{Z}_{t + k - 1} = 1}^{N} P ( {Z}_{t + k} \vert {Z}_{t + k - 1} ) P ( {Z}_{t + k - 1} ) \qquad ( 16 )$$

In Step S23, the measurement information amount computation unit 12 may use the following formula (17) instead of Formula (16).

P(Zₜ₊ₖ)=maxₜ₊ₖ₋₁(P(Zₜ₊ₖ|Zₜ₊ₖ₋₁)P(Zₜ₊ₖ₋₁))/Ω (17)

Note that, for a variable k that specifies the time of the predetermined step from the current time t, 1 is substituted as an initial value.

In Step S24, the measurement information amount computation unit 12 calculates the difference ΔHₜ₊ₖ of information entropies of a future time t+k of the k-th step from the current time t. The difference ΔHₜ₊ₖ of the information entropies can calculate the subscript t in the right side of the above-described Formula (8) as t+k. The same calculation can be performed also when approximations of Formulas (9) and (14) are performed.

In Step S25, the measurement information amount computation unit 12 determines whether or not the difference ΔHₜ₊ₖ of the information entropies to a step prescribed in advance from the current time t. In Step S25, it is determined that the difference ΔHₜ₊ₖ of the information entropies to the defined step has not yet been acquired, the process proceeds to Step S26, k increases by one, and then, the process returns to step S23. Accordingly, the above-described steps S23 and S24 are executed, and the difference ΔHₜ₊ₖ of the information entropies for the next step is calculated.

On the other hand, in Step S25, when the calculation of the difference ΔHₜ₊ₖ of the information entropies to the defined step is determined to end, the process proceeds to Step S27, and then the measurement information amount computation unit 12 acquires predicted time series data of the difference ΔH of predicted information entropies from the current time t to the defined step. Specifically, if the difference ΔH of the information entropies from the current time t to a time t+K of a K-th step is predicted, {ΔHₜ₊₁, ΔHₜ₊₂, ΔHₜ₊₃, . . . , and ΔH_{t+K}} is acquired by the measurement information amount computation unit 12.

In Step S28, the measurement information amount computation unit 12 counts the number of steps in which measurement for predicted time series data of the difference ΔH of the information entropies to the defined step is paused, specifically, the number of steps in which a value greater than the threshold value I_{TH} continues. This count result is supplied from the measurement information amount computation unit 12 to the measurement control unit 13.

In Step S29, the measurement control unit 13 causes the sensor 14 to pause measuring by the counted number supplied from the measurement information amount computation unit 12. The sensor 14 pauses the measurement according to the control of the measurement control unit 13.

After the counted number supplied from the measurement information amount computation unit 12 passes, the measurement control unit 13 causes the sensor 14 to operate so as to start measurement in Step S30. The sensor 14 acquires measured data, and causes the data storage unit 15 to store the data.

As above, by predicting the difference ΔH of information entropies from the current time t to the defined step, the measurement system 1 can determine whether or not measurement to the predetermined step set in advance is performed, and cause the sensor 14 to stop measurement until measurement is determined to be necessary.

### Flowchart of Data Restoration Process

Next, a data restoration process executed by the data restoration unit 16 will be described.

When some of time series data accumulated for a given period of time are missing, the data restoration unit 16 restores the missing data by applying the Viterbi algorithm to the time series data. The Viterbi algorithm is an algorithm to estimate a most likely state series from the given time series data and the Hidden Markov Model.

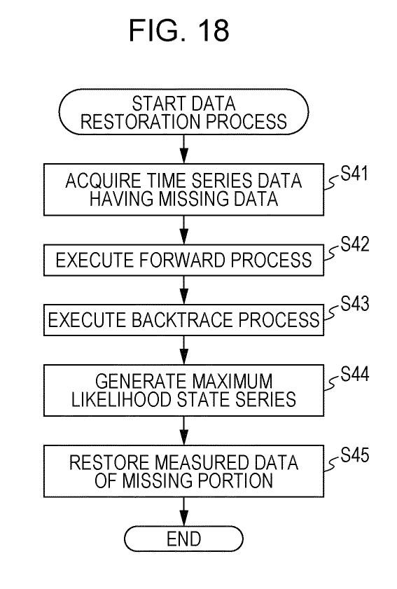

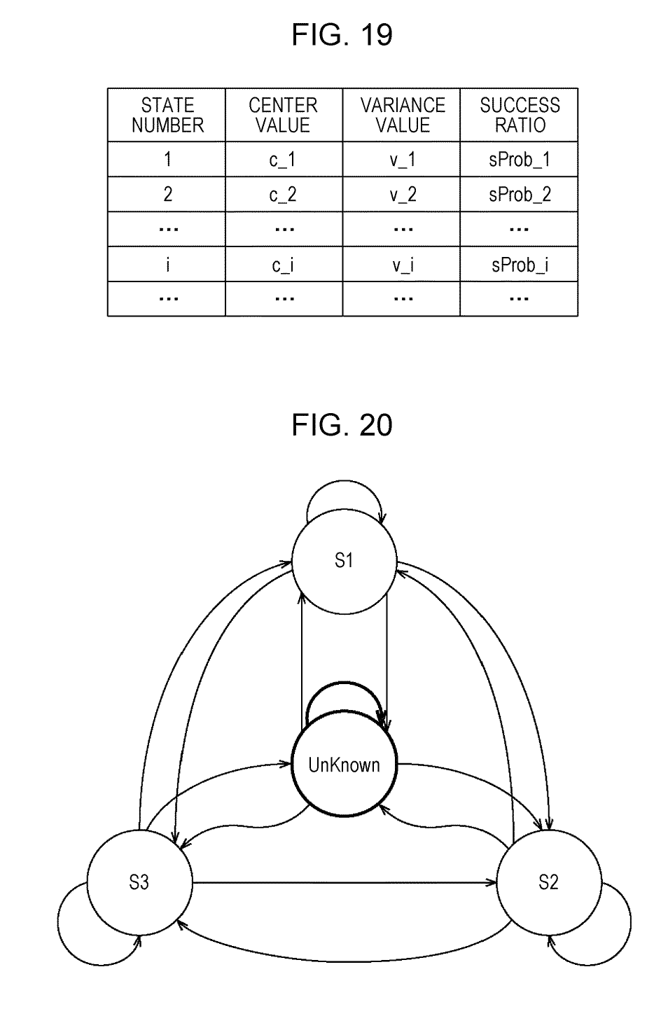

FIG. 18 is a flowchart of a data restoration process executed by the data restoration unit 16. This process is executed at a given timing, for example, a periodical timing such as one time a day, or a timing at which a learning model of the model storage unit 18 is updated.

First, in Step S41, the data restoration unit 16 acquires time series data that is newly accumulated in the data storage unit 15 as a measurement result of the sensor 14. Some of the time series data acquired herein include data missing.

In Step S42, the data restoration unit 16 executes a forward process. Specifically, the data restoration unit 16 computes a probability distribution of each state up to a step t from a step 1 in order with regard to t time series data pieces acquired in the time direction from the step 1 to the step t. The probability distribution of a state Zₜ in the step t is computed using the above-described Formula (15).

For P(Zₜ) of Formula (15), the following Formula (18) is employed so that only a transition having the highest probability among transitions to the state Zₜ is selected.

P(Zₜ)=max(P(Zₜ₋₁|x_{1:t-1}) P(Zₜ|Zₜ₋₁))/Ω (18)

Ω in Formula (18) is a normalization constant of the probability of Formula (18). In addition, the probability distribution of an initial state is given with an equal probability to that of Formula (1) or an initial probability π(Z₁) is used when the initial probability π(Z₁) is known.

In the Viterbi algorithm, when only a transition having the highest probability among transitions to the state Zₜ from the step 1 to the step t in order is selected, it is necessary to store the transition that is selected. Thus, the data storage unit 16 computes and stores a state Zₜ₋₁ of the transition having the highest probability among transitions to the step t by computing mₜ(Zₜ) expressed in the following Formula (19) in the step t. The data restoration unit 16 stores the state of the transition having the highest probability in each state from the step 1 to the step t by performing the same process as that of Formula (19).

mₜ(Zₜ)=argmax_{Z}_{_{t−1}}(P(Zₜ₋₁|x_{1:t-1})P(Zₜ|Zₜ₋₁)) (19)

Next, in Step S43, the data storage unit 16 executes a backtrace process. The backtrace process is a process in which a state having the highest state probability (likelihood) is selected in the opposite direction of the time direction from the newest step t to the step 1 in time series data.

In Step S44, the data restoration unit 16 generates a maximum likelihood state series by arranging states obtained in the backtrace process in a time series manner.

In Step S45, the data restoration unit 16 restores measured data based on the state of the maximum likelihood state series corresponding to a missing data portion of the time series data. It is assumed that, for example, the missing data portion is a data piece of a step p from the step 1 to the step t. When the time series data has discrete symbols, restored data xₚ is generated using the following Formula (20).

xₚ=maxₓ_{ₚ}(P(xₚ|zₚ)) (20)

According to Formula (20), an observation xₚ having the highest likelihood is assigned as restored data in a state zₚ of the step p.

In addition, when the time series data has continuous symbols, a j-dimensional component xₚⱼ of the restored data xₚ is generated using the following Formula (21).

xₚⱼ=μ_{z}_{_{p,j}} (21)

In the process of Step S45, when the measured data is restored for all of the missing data portion of the time series data, the data restoration process ends.

As above, when time series data has missing data, the data restoration unit 16 estimates a maximum likelihood state series by applying the Viterbi algorithm, and restores measured data corresponding to the missing data portion of the time series data based on the estimated maximum likelihood state series.

Note that, in the present embodiment, data is generated (restored) only for a missing data portion of time series data based on the maximum likelihood state series, but data may be generated for entire time series data so as to be used in updating of a learning model.

The measurement system 1 configured as above can be configured by an information processing device on which the sensor 14 is mounted and a server that learns a learning model and supplies parameters of the learned learning model to the information processing device. In this case, the information processing device includes the time series data input unit 11, the measurement information amount computation unit 12, the measurement control unit 13, the sensor 14, and the data storage unit 15. In addition, the server includes the data restoration unit 16, the model updating unit 17, and the model storage unit 18. Then, the information processing device periodically transmits time series data accumulated in the data storage unit 15 to the server one time a day, or the like, and the server updates a learning model when the time series data is added and supplies parameters after updating to the information processing device. The information processing device can be a mobile device, for example, a smartphone, a tablet terminal, or the like. When the information processing device has processing capability of learning a learning model based on accumulated time series data, the device may of course have the entire configuration of the measurement system 1.

### 2. Second Embodiment

Embodiment Considering a Case in which Measurement Fails

In the above-described first embodiment (in description of a second embodiment, the first embodiment is referred to as a basic embodiment), it is assumed that measurement by the sensor 14 surely succeeds in the future including the current time. In the above-described example, however, a case in which the sensor 14 fails measurement as missing data is included in time series data of the past is also considered. When the sensor 14 is a GPS sensor that acquires a current location, for example, the GPS sensor may not acquire the current location as the sensor is not able to find a satellite because it is located in a vehicle, an indoor place, or the like. In addition, even if measurement succeeds, a case in which the accuracy of measurement becomes worse is also considered.

Thus, as a modified example of the above-described basic embodiment, an example considering a case in which measurement by the sensor 14 fails will be described next. Note that, in the following description, the description of the same portion as in the basic embodiment will not be appropriately repeated.

First, when a case in which measurement fails is considered, the probability distribution (prior probability) P(Zₜ) and the information entropy H_{b} of a state when measurement is not performed are the same as those in the basic embodiment. In other words, the probability distribution (prior probability) P(Zₜ) of the state when measurement is not performed is:

$$P ( {Z}_{t} ) = P ( {Z}_{t} \vert {x}_{1 : t - 1} ) = {\sum }_{{Z}_{t - 1} = 1}^{N} P ( {Z}_{t} \vert {Z}_{t - 1} ) P ( {Z}_{t - 1} ) \qquad ( 3 )$$

and the information entropy H_{b} when measurement is not performed is:

$$\begin{matrix}{H}_{b} = H ( {Z}_{t} ) \\ = - {\sum }_{{Z}_{t} = 1}^{N} P ( {Z}_{t} \vert {x}_{t} ) log P ( {Z}_{t} \vert {x}_{t} ) \\ = - {\sum }_{{Z}_{t} = 1}^{N} P ( {Z}_{t} ) log P ( {Z}_{t} )\end{matrix} \qquad ( 6 )$$

On the other hand, the probability distribution P(Zₜ|Xₜ) of the posterior probability and the information entropy Hₐ when measurement is performed at a time t are different from those of the basic embodiment since a case in which measurement is intended but fails has to be considered.

In the second embodiment considering the case in which measurement fails, a probability of measurement succeeding (success ratio) sProb_i is newly added to each state i in a state table in which observation probabilities of each state shown in FIGS. 8A and 8B are stored, as shown in FIG. 19. Note that, in FIG. 19, a center value c_i corresponding to a state i is one expressed by simplifying the center value cᵢⱼ (j=1, 2, . . . , j, . . . , and J) of FIG. 8A, and a variance value v_i corresponding to the state i is one expressed by simplifying the variance value vᵢⱼ (j=1, 2, . . . , j, . . . , and J) of FIG. 8B.

A success ratio sProb_i of FIG. 19 is given, for example, as follows. First, parameters of a learning model are decided using time series data prepared as learning data, and states are given to each measured data piece of the time series data using the learning model. Then, each measured data piece of the time series data is classified for each state, each frequency probability is obtained from the number of times of succeeding measurement and the number of times of failing measurement in the states, and the success ratio sProb_i is thereby obtained.

The state table of FIG. 19 can be regarded as one type of a state table when discrete symbols are observed in which a probability of observing either of two symbols Mₜ including a symbol called measurement success (Mₜ=0) and a symbol called measurement failsure (Mₜ=1) is stored. In other words, the state table of FIG. 6 can be used as a case in which there are two kinds of discrete symbols. At this moment, in a state Z, the probability of succeeding measurement is expressed by P(M=0|Z). In addition, a probability distribution (posterior probability) P(Zₜ|Xₜ, Mₜ) when measurement is performed can be expressed by Formula (22).

$$P ( {Z}_{t} \vert {X}_{t} , {M}_{t} ) = \frac{P ( {M}_{t} \vert {Z}_{t} ) P ( {Z}_{t} )}{{\sum }_{{Z}_{t} = 1}^{N} P ( {X}_{t} , {M}_{t} \vert {Z}_{t} ) P ( {Z}_{t} )} \qquad ( 22 )$$

Furthermore, an information entropy Hₐ′ when measurement is performed can be expressed by Formula (23).

$${H}_{a}^{′} = - {\sum }_{{M}_{t} = 0}^{1} \int d {X}_{t} {\sum }_{{Z}_{t} = 1}^{N} P ( {X}_{t} , {M}_{t} \vert {Z}_{t} ) P ( {Z}_{t} ) log \frac{P ( {X}_{t} , {M}_{t} \vert {Z}_{t} ) P ( {Z}_{t} )}{{\sum }_{{Z}_{t}^{′} = 1}^{N} P ( {X}_{t} , {M}_{t} \vert {Z}_{t}^{′} ) P ( {Z}_{t}^{′} )} \qquad ( 23 )$$

As a result, the difference ΔH of the information entropies when measurement by the sensor 14 is performed and not performed is expressed as follows using Formulas (6) and (23).

$$Δ H = {H}_{a}^{′} - {H}_{b} = - {\sum }_{{Z}_{t} = 1}^{N} P ( {M}_{t} = 0 \vert {Z}_{t} ) \int d {X}_{t} P ( {X}_{t} \vert {Z}_{t} ) P ( {Z}_{t} ) log \frac{P ( {M}_{t} = 0 \vert {Z}_{t} ) P ( {X}_{t} \vert {Z}_{t} )}{{\sum }_{{Z}_{t}^{′} = 1}^{N} P ( {M}_{t} = 0 \vert {Z}_{t}^{′} ) P ( {X}_{t} \vert {Z}_{t}^{′} ) P ( {Z}_{t}^{′} )} \qquad ( 24 )$$

Formula (24) is equivalent to a formula formed by substituting a likelihood P(Xₜ|Zₜ) in which a probability variable Xₜ is obtained from a state Zₜ with a likelihood P(Mₜ=0|Zₜ)P(Xₜ|Zₜ) in which measurement succeeds in the state Zₜ and the probability variable Xₜ is thereby obtained in Formula (8) of the difference ΔH of information entropies in the basic embodiment.

With regard to the difference ΔH of information entropies of Formula (24), an approximation to avoid numerical integration every time can be performed in the same manner as in the basic embodiment. If an approximation to substitute the continuous variable Xₜ with a discrete variable Xₜ^{˜} (variable conversion) is performed for Formula (24), the following Formula (25) is obtained.

$$Δ H = - {\sum }_{{Z}_{t} = 1}^{N} P ( {M}_{t} = 0 \vert {Z}_{t} ) P ( {Z}_{t} ) {\sum }_{{X}_{t}^{∼} = 1}^{N} P ( {X}_{t}^{∼} \vert {Z}_{t} ) log \frac{P ( {M}_{t} = 0 \vert {Z}_{t} ) P ( {X}_{t}^{∼} \vert {Z}_{t} )}{{\sum }_{{Z}_{t}^{′} = 1}^{N} P ( {M}_{t} = 0 \vert {Z}_{t} ) P ( {X}_{t}^{∼} \vert {Z}_{t}^{′} ) P ( {Z}_{t}^{′} )} \qquad ( 25 )$$

Formula (25) is equivalent to a formula formed by substituting the likelihood P(Xₜ|Zₜ) in which the probability variable Xₜ is obtained from the state Zₜ with a likelihood P(Mₜ=0|Zₜ)P(Xₜ|Zₜ) in which measurement succeeds in the state Zₜ and the probability variable Xₜ is thereby obtained in an approximation Formula (9) of the difference ΔH of information entropies in the basic embodiment.

If variable conversion is performed for a state variable Z obtained by learning time series data with high efficiency, and simplification is further performed so as to have rᵢⱼ=δᵢⱼ in the same manner, Formula (25) is expressed by Formula (26).

$$Δ H = {\sum }_{{Z}_{t} = 1}^{N} P ( {M}_{t} = 0 \vert {Z}_{t} ) P ( {Z}_{t} ) log P ( {Z}_{t} ) \qquad ( 26 )$$

As above, by adding a success ratio sProb_i of each state i as a state parameter, the difference ΔH of information entropies is calculated in consideration of the case in which measurement fails, and a sensing control based on the calculation result can thereby be performed.

### 3. Third Embodiment

Embodiment Considering being in an Unknown State

In the above-described first and second embodiments (in description of a third embodiment, the first and the second embodiments are referred to as basic embodiments), it is assumed that a current state of a state variable estimated through measurement is surely included in a model. However, in states prepared in the model, treatment of data that is hard to be expressed is also considered. When the sensor 14 is a GPS sensor that acquires a current location, for example, and when a user is located at a place where the user has not visited, the place is difficult to be modeled with a state variable, and thus the model is difficult to express the state.

Hence, by further modifying the above-described basic embodiment and modified example, an example considering a case in which observation data is difficult to be expressed using an existing model will be described. Note that, in the following description, description of the same portions as in the basic embodiment and the above-described modified example will not be appropriately repeated.

First, a state transition diagram of a model when an unknown state is included is considered. As shown in FIG. 20, for example, a state transition diagram when an unknown state is added to the state transition diagram of a model including three states of FIG. 5 is considered. The model in which an unknown state is present can be set as a model in which only one unknown state is added to the state transition diagram in addition to the existing states in that manner.

In addition, as a method for deciding a transition parameter and a state parameter of this unknown state, for example, there is a method disclosed in Japanese Unexamined Patent Application Publication No. 2012-8659 invented by the inventors of the present disclosure, or the like.

According to the present document, the state parameter of this unknown state can:

attain transition from all states to an unknown state with a given probability;

attain transition conversely from an unknown state to all states with a given probability; and

be set such that, with regard to the center and a variance of the unknown state, the center may be an arbitrary position, but the variance is a large variance the same as a possible range of an observation if the observation handles a continuous amount.

Note that, among methods for deciding the state parameters, the parameter in the state shown third can be treated more simply. With regard to an unknown state, instead of preparing state parameters of the center, the variance, and the like, for example, there is a method in which only a likelihood P(X|Z=zᵤ) calculated using the parameters is prepared in advance. Herein, zᵤ indicates an unknown state, and the number of states of the Hidden Markov Model considering the unknown state is N+1 by adding 1 to the number of states N of the existing model. In addition, the range of an observation X is decided in advance and the value is constant in the range, but is 0 if the value exceeds the range.

To summarize the above, when an unknown state is considered, a model considering the unknown state can be generated by adding the following probabilities to the parameter of the existing Hidden Markov Model:

a transition probability P(Z=Zᵤ|Z=Zᵢ) (i=1, . . . , N) from all states to the unknown state;

a transition probability P(Z=Zᵢ|Z=Zᵤ) from the unknown state to all states; and

a likelihood P(X|Z=zᵤ) in which an observation is obtained from the unknown state.

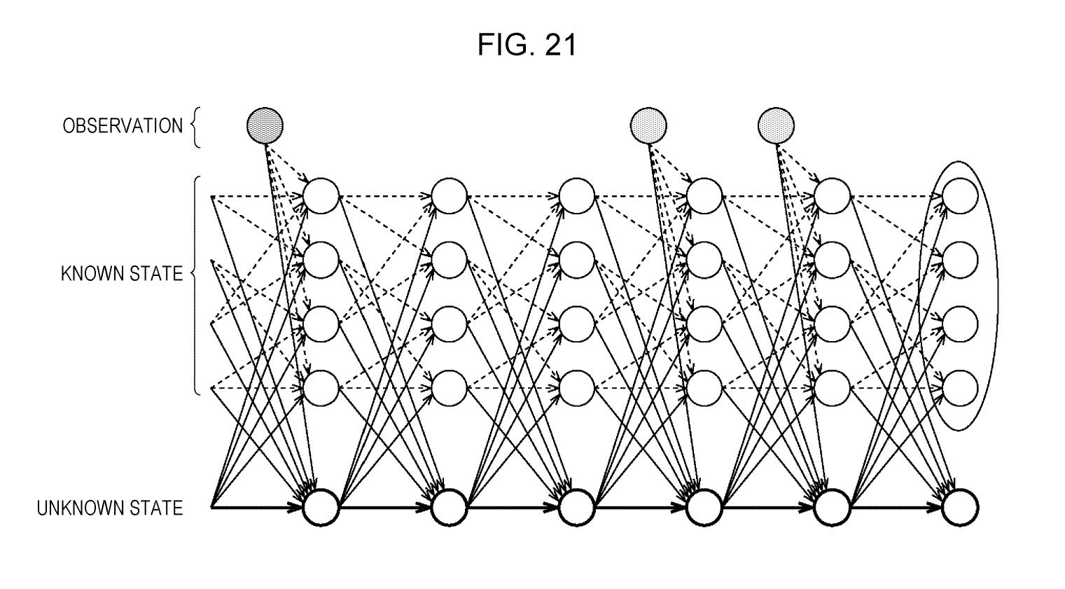

FIG. 21 is a trellis diagram when one unknown state is added so as to consider the unknown state based on the trellis diagram when there are four known states as shown in FIG. 11.

As shown in FIG. 21, the unknown state in the Hidden Markov Model in which this unknown state is included can be transitioned from and to all of the known states. In addition, the transition probabilities are decided in advance.

Note that, in FIG. 21, there are inputs from observations to the unknown state, but the inputs are not necessary at all times. Such an input is set when a dummy input is necessary, but when the likelihoods of the unknown state are decided in advance as described above, it is not necessary to set an input.

As above, by deciding the transition probabilities from the known states to the unknown state, the transition probabilities from the unknown state to the known state, and the likelihood of the unknown state in advance, the case in the trellis drawing shown in FIG. 21 can be treated in the same manner as the case in the trellis drawing shown in FIG. 11.

In other words, by treating the trellis diagram as in FIG. 21, the above-described prior probability and posterior probability can be obtained also in a model that includes an unknown state. In addition, Formula (3) for the prior probability and Formula (4) or (22) for the posterior probability can be replaced by a formula formed by substituting the number of states N with the number of states N+1 including an unknown state.

Finally, the computation of an information entropy when there is an unknown state will be described.

For an information entropy when there is an unknown state, an information entropy in an unknown state has to be considered. In this case, the information entropy in an unknown state is the same as or larger than that when all of the known state are equally generated. Thus, the information entropy in the unknown state is considered as the information entropy when the known states are equally generated. Under this assumption, first, the information entropy H_{b} when measurement is not performed is expressed by Formula (27).

$$\begin{matrix}{H}_{b} = - {\sum }_{{Z}_{t} = 1}^{N} P ( {Z}_{t} ) log P ( {Z}_{t} ) + P ( {Z}_{t} = {z}_{u} ) log N \\ = - {\sum }_{{Z}_{t} = 1}^{N + 1} P ( {Z}_{t} ) log P ( {Z}_{t} ) + P ( {Z}_{t} = {z}_{u} ) log NP ( {Z}_{t} = {z}_{u} )\end{matrix} \qquad ( 27 )$$

The information entropy H_{b} of Formula (27) is obtained by further adding P(Zₜ=zᵤ)Log N to the information entropy H_{b} of the first line of Formula (6) up to this time. This additional term is obtained by adding the information entropy when a state is unknown.

On the other hand, the information entropy Hₐ when measurement is performed can be expressed as below using a posterior probability in the same manner as in Formula (7).

$$\begin{matrix}{H}_{a} = - \int d {X}_{t} {\sum }_{{Z}_{t} = 1}^{N + 1} P ( {Z}_{t} \vert {X}_{t} ) log P ( {Z}_{t} \vert {X}_{t} ) \\ = - \int d {X}_{t} {\sum }_{{Z}_{t} = 1}^{N + 1} P ( {X}_{t} \vert {Z}_{t} ) P ( {Z}_{t} ) log \frac{P ( {X}_{t} \vert {Z}_{t} ) P ( {Z}_{t} )}{{\sum }_{{Z}_{t}^{′} = 1}^{N + !} P ( {X}_{t} \vert {Z}_{t}^{′} ) P ( {Z}_{t}^{′} )}\end{matrix} \qquad ( 28 )$$

A difference of Formula (28) from Formula (7) is the section to be added spans from 1 to N+1, not from 1 to N. Formula (27) does not use the assumption that N states occur with the same probability of 1/N in an unknown state, different from Formula (28). The reason is that a state variable is difficult to be estimated from data of an unknown state when measurement is not performed, but if measurement is performed and it is ascertained that an observation obtained as a result of the measurement is an unknown state, adding a state in which the obtained observation is generated newly to a model is possible.

Thus, from Formulas (27) and (28), the difference ΔH of the information entropies is as below.

$$Δ H = {H}_{a} - {H}_{b} = - \int d {X}_{t} {\sum }_{{Z}_{t} = 1}^{N + 1} P ( {X}_{t} \vert {Z}_{t} ) P ( {Z}_{t} ) log \frac{P ( {X}_{t} \vert {Z}_{t} )}{{\sum }_{{Z}_{t}^{′} = 1}^{N + !} P ( {X}_{t} \vert {Z}_{t}^{′} ) P ( {Z}_{t}^{′} )} - P ( {z}_{u} ) log NP ( {z}_{u} ) \qquad ( 29 )$$

In the same manner as the above-described embodiments, if an approximation in which states are uniformly decided by performing measurement is performed, Formula (29) can be modified as below.

$$Δ H ≅ {\sum }_{{Z}_{t} = 1}^{N} P ( {Z}_{t} ) log P ( {Z}_{t} ) - P ( {Z}_{t} = {z}_{u} ) log N \qquad ( 30 )$$

In addition, states are uniformly decided if measurement succeeds, but when failure is also considered, Formula (29) can be expressed as below.

$$Δ H ≅ {\sum }_{{Z}_{t} = 1}^{N} P ( {M}_{t} = 0 \vert {Z}_{t} ) P ( {Z}_{t} ) log P ( {Z}_{t} ) - P ( {Z}_{t} = {z}_{u} ) log N \qquad ( 31 )$$

### 4. Fourth Embodiment

In the above-described embodiments, the example in which time series data of the past is learned using the Hidden Markov Model and an information amount of measurement by the sensor 14 is predicted has been described.

However, as described above with reference to FIG. 1, an information amount of measurement by the sensor 14 can also be predicted using time series data of the past stored in the model storage unit 18 as a database without change. Thus, in a third embodiment, a method for storing and using time series data of the past in the model storage unit 18 as a database without change will be described. Note that, in description hereinbelow, the model storage unit 18 of the measurement system 1 of FIG. 1 will be replaced by a database storage unit 18, and other configuration of the measurement system 1 will be appropriately adopted.

The time series data input unit 11 supplies time series data x_{1:L} having a predetermined length (number of steps) L obtained most recently and stored in the data storage unit 15 as a data buffer to the measurement information amount computation unit 12.

The measurement information amount computation unit 12 extracts time series data z_{t-L:t} having a t-th (t=1, . . . , T−L) piece as the tail with the same length L as that of the most recent time series data x_{1:L} from time series data z_{1:T} of the past having a length T stored in the database storage unit 18, and computes a degree of similarity D(x_{1:L}, z_{t-L:t}) of the extracted section and the most recent time series data x_{1:L}. For the computation of the degree of similarity D(x_{1:L}, z_{t-L:t}), a Euclidean distance of the most recent time series data x_{1:L} and the time series data z_{t-L:t} having the same length L expressed in, for example, Formula (32) below can be employed.

$$D ( {x}_{1 : L} , {z}_{t - L : t} ) = {\sum }_{l = 1}^{L} {‖ {x}_{l} - {x}_{t - L + l} ‖}^{2} \qquad ( 32 )$$

In Formula (32), the time series data z_{t-L:t} indicates time series data having the length L with serial numbers z_{t-L} to zₜ extracted from the database storage unit 18 as data obtained by giving the serial number zₜ (t=1, . . . , T) to data of each step stored in the database storage unit 18.

The measurement information amount computation unit 12 computes the degree of similarity D(x_{1:L}, z_{t-L:t}) of all places in the database, more specifically, all places at which the tail is in a t-th (t=L, . . . , T−L) order and the most recent time series data x_{1:L} by performing calculation over the entire time series data of the past stored in the database storage unit 18 from the serial number z_{t-L}=1 in order.

The likelihood P(x_{1:L}|z_{t-L:t}) in which the most recent time series data x_{1:L} is observed from the one time series data piece z_{t-L:t} extracted from the database storage unit 18 is expressed by the following Formula (33).

$$P ( {x}_{1 : L} , {z}_{t - L : t} ) = exp ( - \frac{β}{2} D ( {x}_{1 : L} , {z}_{t - L : t} ) ) \qquad ( 33 )$$

Wherein, β is a predetermined coefficient.

Furthermore, using this likelihood P(x_{1:L}|z_{t-L:t}), the posterior probability P(z_{t-L:t}|x_{1:L}) of the time series data Z_{t-L:t} when the most recent time series data x_{1:L} is obtained is acquired using the following Formula (34) in the form of contribution of the time series data Z_{t-L:t} when the most recent time series data x_{1:L} is obtained.

$$\begin{matrix}P ( {z}_{t - L : t} \vert {x}_{1 : L} ) = \frac{P ( {x}_{1 : L} \vert {z}_{t - L : t} ) P ( {z}_{t - L : t} )}{{\sum }_{t = 1}^{T} P ( {x}_{1 : L} \vert {z}_{t - L : t} ) P ( {z}_{t - L : t} )} \\ = \frac{P ( {x}_{1 : L} \vert {z}_{t - L : t} )}{{\sum }_{t = 1}^{T} P ( {x}_{1 : L} \vert {z}_{t - L : t} )}\end{matrix} \qquad ( 34 )$$

Modification of the first and second lines of the right side of Formula (34) is based on the assumption that the contribution of the extracted time series data z_{t-L:t} is constant and P(z_{t-L:t)}=1. In addition, the summation (Σ) of Formula (34) indicates the sum obtained when the serial number z_{t-L} is changed over the entire time series data of the past stored in the database storage unit 18.

By doing this, the prior probability P(Z_{T+1}) for data X_{L+1}=Z_{T+1} of the next step (a T+1-th step in the number of time series data Z and a L+1-th step in the number of time series data x) can be predicted as below.

P(Z_{T+1})=ΣP(z_{t-L:t}|X_{1:L})N(Z_{T+1}|zₜ₊₁,σ²) (35)

Herein, X_{L+1} and Z_{T+1} are differently used, but X_{L+1} means data obtained by measurement, and Z_{T+1} means real data. A state variable to calculate an information amount means being real data Z_{T+1}. In addition, X_{L+1}=Z_{T+1} is present, but this is because it is assumed that there is no measurement error, and when there is no measurement error, an observation variable and a state variable are the same. On the other hand, when there is a measurement error, the data X_{L+1} obtained from measurement does not necessarily coincide with the real data Z_{T+1}, but the following description will proceed on the assumption that an observation X indicating data obtained from measurement coincides with a state variable Z indicating real data.

In Formula (35), N(Z|z, σ²) indicates a normal distribution in which data is distributed with the variance ν² having z as the center. In addition, Formula (35) assumes that the next observation X_{L+1} (=Z_{T+1}) is a probability variable distributed with the variance σ² decided in advance having, as the center, a position zₜ₊₁ in one step ahead of the time series data z_{t-L:t} extracted from the database storage unit 18.

Based on the above, since a prior distribution P(X_{L+1}=Z_{T+1}) for the observation X_{L+1} (=Z_{T+1}) is obtained, the information entropy H_{b} when measurement is not performed using the prior distribution P(X_{L+1}=Z_{T+1}) can be expressed by Formula (36).

H_{b}−∫dZ_{T+1}P(Z_{T+1})log P(Z_{T+1}) (36)

On the other hand, when measurement is performed, data X_{L+1}=Z_{T+1} is uniformly decided. Thus, the information entropy Hₐ when measurement is performed is 0(Hₐ=0).

As a result, the difference ΔH of the information entropies when the time series data of the past is stored as a database without change is expressed by Formula (37).

ΔH=Hₐ−H_{b}=∫dZ_{T+1}P(Z_{T+1})log P(Z_{T+1}) (37)

The difference ΔH of the information entropies when the time series data of the past is stored as a database without change can be computed as above, and based on the computed difference ΔH of the information entropies, the measurement by the sensor 14 can be controlled.

Note that, in the above-described description, the information entropy Hₐ is necessarily set to be 0. This is based on the assumption that data x obtained from observation is necessarily real data. However, in most cases, the data x obtained from observation includes an error with regard to real data z. After all, the example in which the above-described information entropy Hₐ is necessarily 0 is an example when a state variable z indicating the real data coincides with an observation variable x indicating measured data. If the measured data does not coincide with the real data, and the measurement result includes data, a standard deviation and a variance indicating a margin of error, or any degree of confidence, the information entropy Hₐ does not become 0 by being incorporated with such information. Methods for computing the size of the information entropy in this case differ according to ways of presenting errors. For example, it is assumed that j-dimensional components of an observation and an error are present as a measured value xᵢⱼ and a standard deviation eᵢⱼ² of the error with regard to an i-th observation Xᵢ. In this case, j-dimensional real data Zᵢⱼ of i-th real data Zᵢ is considered to be present in the range of the normal distribution of the variance eᵢⱼ² having the measured value xᵢⱼ as the center. Thus, the information entropy Hₐ having a state variable Z is:

$${H}_{a} = \int {\prod }_{j = 1}^{D} d {Z}_{ij} N ( {Z}_{ij} \vert {x}_{ij} , {e}_{ij}^{2} ) P ( {Z}_{ij} ) log N ( {Z}_{ij} \vert {x}_{ij} , {e}_{ij}^{2} ) P ( {Z}_{ij} )$$

and is not necessarily 0. Wherein, P(Zᵢⱼ) the prior probability of j-dimensional components of prediction Zᵢ of the i-th real data, obtained from Formula (35).

### 5. Application Example of Application

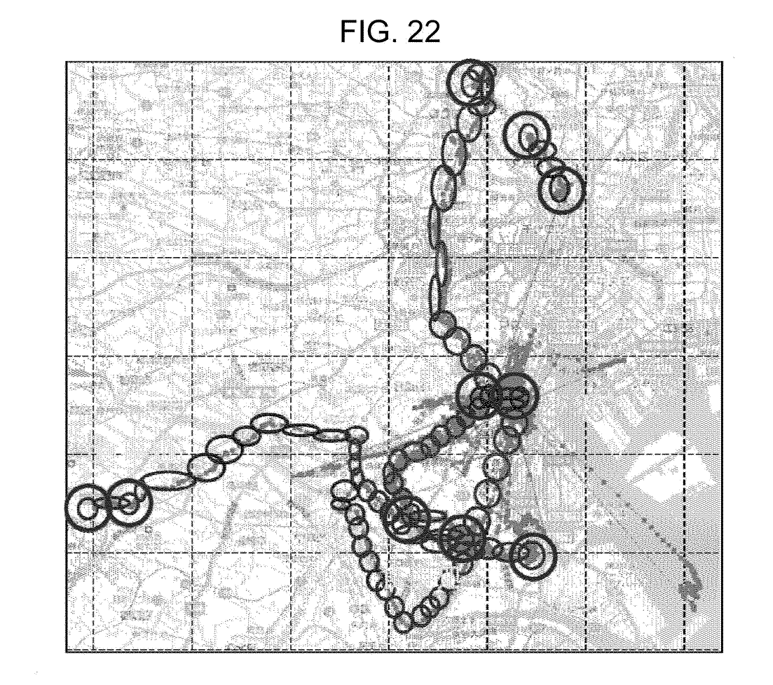

Next, Cases to which the above-described measurement system 1 is applied will be described with reference to FIGS. 22 to 29. The cases to be described below are, with the sensor 14 as a GPS sensor, to learn a past movement history of a user using the Hidden Markov Model so as to control operations of the GPS sensor mounted on mobile devices, or the like for current movements of the user.

When the GPS sensor mounted on a mobile device, or the like is operated, a battery of the mobile device is consumed. Thus, power consumption caused by the operation of the GPS sensor can be considered as measurement costs, and if such measurement costs are not incurred, the GPS sensor may be operated at all times, but in reality, since costs are incurred due to measurement, it is necessary to perform measurement with high efficiency while suppressing measurement costs. If the user is continuously located (stays) at the same position, for example, acquiring data for the time being is meaningless, and thus, it is desirable to pause measurement. On the contrary, if the user moves, it is desirable to more closely acquire data than when he or she stays.

More specifically, as general requests when the GPS sensor mounted on a mobile device, or the like is operated, the following items are present.

If a user currently moves, the number of measurement times is desired to increase. On the contrary, if the user is predicted to stay for a while, the number of measurement times is desired to decrease.

If a location is a road that the user has passed through (once or several times) in the past, and thus can be predicted without measurement, the number of measurement times is desired to decrease.

Even if a movement history (observation data) is sparsely present due to reduced number of measurement times, data filling is performed later so as to restore data the same as a portion of which the acquisition intervals are dense.

Even if a predicted path is a known road, in a branch, or the like, measurement is desired to be performed so as to know the end of the.

If a predicted path is a tunnel, a valley, or the like, so that measurement is difficult, measurement is desired to pause.

According to the measurement system 1 to which the present technology is applied, the above requests are uniformly processed by computing the difference ΔH of information entropies when measurement by the GPS sensor is performed and not performed, and the operation of the GPS sensor can thereby be controlled.

### Hidden Markov Model

FIG. 22 shows a learning result obtained by learning a movement history of a user using the Hidden Markov Model.

In FIG. 22, learning data is a past movement history of the user, and times series data including times, latitude, and longitude measured by the GPS sensor when the user moved in the past. In addition, each of a plurality of ellipses disposed so as to cover the movement path in FIG. 22 shows contour lines of probability distributions of measured data generated from the state of the Hidden Markov Model.

Center values and variance values of states corresponding to each of the plurality of ellipses shown in FIG. 22 are stored in the model storage unit 18 in the forms of FIGS. 8A and 8B as state tables. In addition, success ratios of the states corresponding to each of the plurality of ellipses shown in FIG. 22 are also stored in the model storage unit 18 in the form of FIG. 19 as a state table. Further, transition probabilities between states corresponding to each of the plurality of ellipses shown in FIG. 22 are stored in the model storage unit 18 in the form of FIG. 6. Note that computation methods for model parameters of the Hidden Markov Model are disclosed in Japanese Unexamined Patent Application Publication Nos. 2011-59924 and 2012-8659 which are patent documents by the inventors of the present disclosure, and the like.

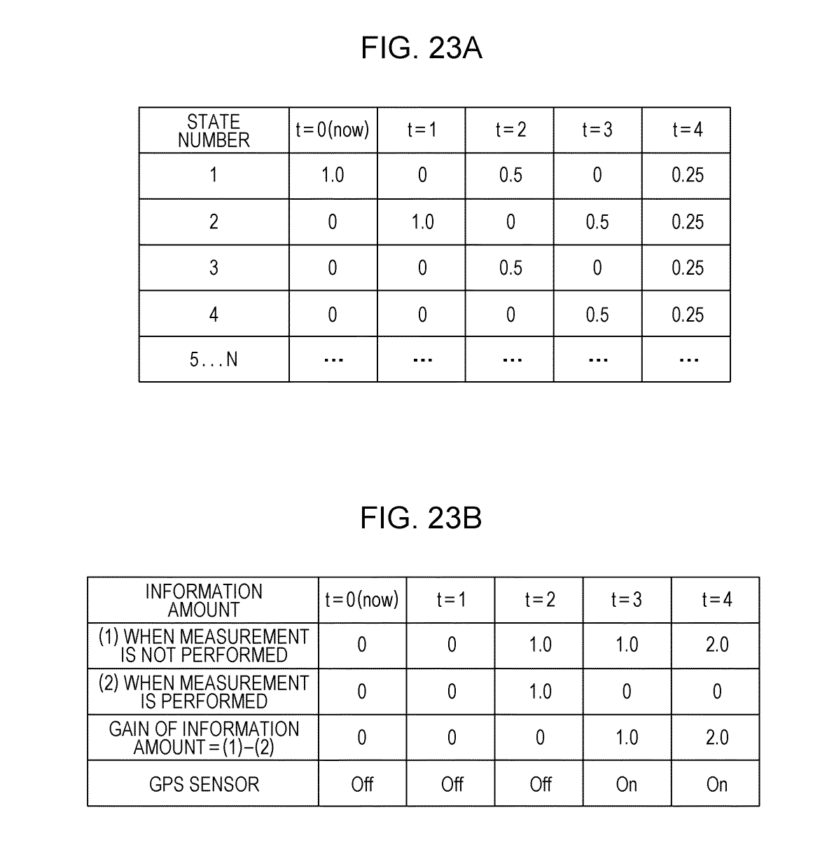

FIGS. 23A and 23B show a probability distribution of states in future times that is computed based on the learned Hidden Markov Model and information amounts predicted based on the probability distribution.

FIG. 23A is a table showing the probability distribution of states in future times that is computed based on the learned Hidden Markov Model.

In FIG. 23A, the time t=0 corresponds to the current time, and the time t=1, 2, 3, and 4 indicate the future. In the example shown in FIG. 23A, a state is defined solely to be the state 1 with the probability 1 at the time t=0, and solely to be the state 2 with the probability 1 at the time t=1. On the other hand, a state is defined to be any one of two states of the states 1 and 3 with the probability 0.5 at the time t=2, any one of two states of the states 2 and 4 with the probability 0.5 at the time t=3, and any one of four states of the states 1 to 4 with the probability 0.25 at the time t=4.

FIG. 23B shows information amounts calculated from the probability distribution of FIG. 23A and the levels of operation of the sensor 14 controlled based on the information amounts.

Note that FIG. 23B shows values obtained by computing the information amounts when measurement is performed and not performed, but the values are not directly calculated in reality. The values are present on supposition in FIG. 23B in order to make understanding easy.

In FIG. 23B, the information amount when measurement is not performed are 0.0, 0.0, 1.0, 1.0, and 2.0 in order according to times t=1, 2, 3, and 4 by setting the current time t=0. This means that states are not uniformly decided according to prediction of the future distant from the current time.

On the other hand, the information amounts when measurement is performed are 0.0, 0.0, 1.0, 0.0, and 0.0 in order according to times t=1, 2, 3, and 4. Since that an information amount is “0.0” indicates the states are uniformly decided, it means that the states are uniformly decided through measurement even at a future time. However, when t=2, the information amount is 1.0 which is the same as when measurement is not performed. This means that the amount is the same when measurement is performed and not performed, implying that measurement fails. Therefore, the information amount when measurement is performed has a value considering a case in which measurement is performed but fails.

The fourth line from the top of FIG. 23B indicates a gain of information amounts at each time, and the next fifth line indicates control results obtained by controlling the level of operation of the GPS sensor based on the gain of the information amounts in the fourth line.

A gain of information amounts is a value obtained by subtracting an information amount when measurement is performed from an information amount when measurement is not performed, and corresponds to a mutual information amount of Formula (8) with a reverse sign of the difference ΔH of information entropies. Since the information amount (information entropy Hₐ) when measurement is performed is smaller than the information amount when measurement is not performed (information entropy H_{b}), the difference ΔH of the information entropies is negative at all time, as clear from Formula (8). In other words, this means that, as the difference ΔH of the information entropies is small, the information amount obtained from measurement is large, but it is easy for a human to instantaneously think of performing measurement when the information amount obtained from measurement is large. Thus, hereinbelow, description will be provided using the terms of a gain of information amounts having a reversed sign to the difference ΔH of the information entropies.

The gains of information amounts are 0.0, 0.0, 0.0, 1.0, and 2.0 in order as the times t=0, 1, 2, 3, and 4. Thus, when the time t=0 and 1, the gain of the information amounts is not obtained, and even when the time t=2 at which measurement is predicted to fail, the gain of the information amounts is not obtained. Then, when the time t=3 and 4, the gain of the information amounts is obtained for the first time.

In the example of FIGS. 23A and 23B, a threshold value I_{TH} for determining whether or not the GPS sensor is operated is set to be 1.0 (I_{TH}=1.0). When the time t=0, 1, and 2, the gain of the information amounts is 0, it is determined that much information is not obtained even if the GPS sensor is operated, and accordingly, the GPS sensor is controlled to be turned off. On the other hand, when the times t=3 and 4, the gain of the information amounts is 1.0 or higher, and thus it is determined that much information is obtained from an operation of the GPS sensor, and the GPS sensor is controlled to be turned on. Therefore, the measurement information amount computation unit 12 schedules to set the GPS sensor to be in a sleep mode until the time t=2, and to operate the GPS sensor at the time t=3. Accordingly, data can be collected with higher efficiency than when the GPS sensor is operated at an equal interval.

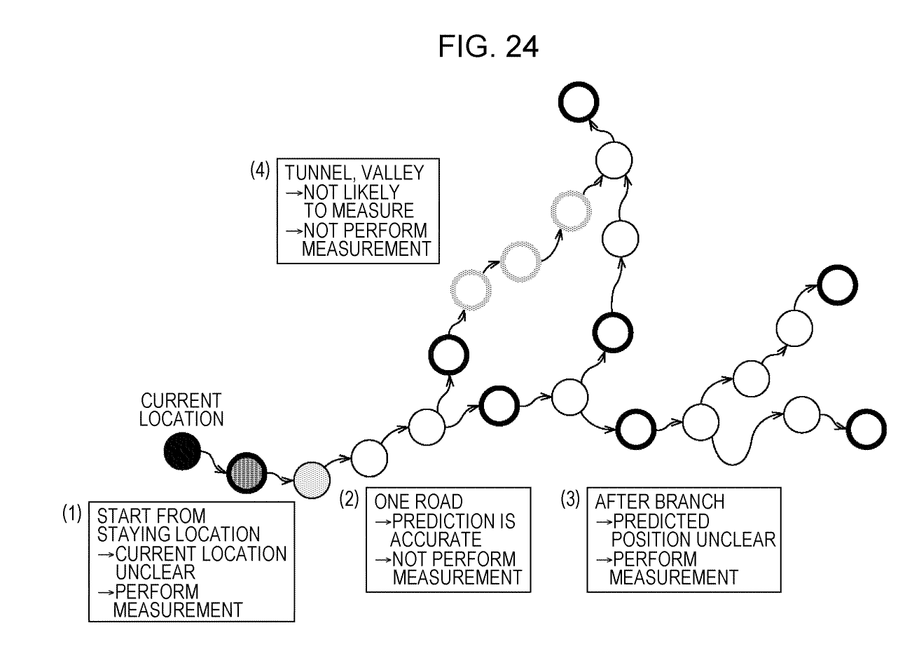

With reference to FIGS. 24 to 29, an example in which the operation of the GPS sensor is controlled based on the Hidden Markov Model with which a movement history of a user is learned will be described in more detail.

FIG. 24 shows a part of state transition of the Hidden Markov Model with which a movement history of a user is learned.

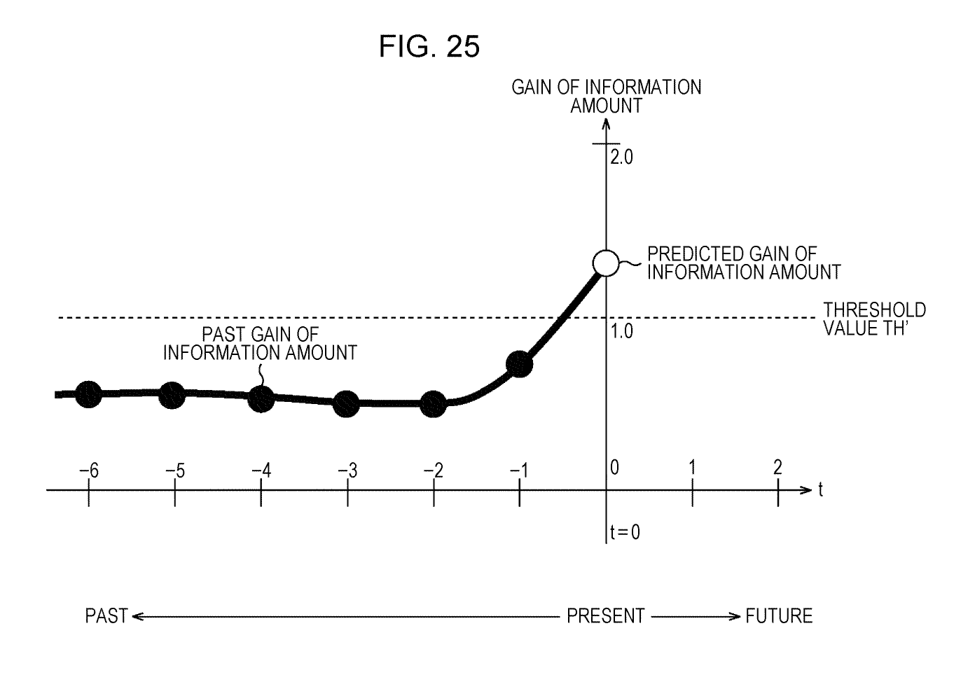

FIGS. 25 to 28 describe four requests shown in FIG. 24.

(1) If a state corresponding to a current value is unclear, measurement is performed.

(2) If the path to the movement destination is one road, and there is one transition between future states (states are uniformly decided), measurement is not performed.
(3) When there is a branch as a transition between future states, measurement is performed at a position past the branched point.
(4) If measurement is not possible due to staying at a tunnel or a valley, measurement is not performed.

FIG. 25 is a diagram describing the request “(1) if a state corresponding to a current value is unclear, measurement is performed” using gains of information amounts.

In FIGS. 25 to 28, the black circles in the drawings indicates known gains of information amounts at past times, and the white circles indicate future gains of information amount obtained through prediction.

If a current state (current location) is unclear, the gain of information amounts when measurement is performed at the current time t=0 becomes large as shown in FIG. 25. Thus, the request “(1) if a state corresponding to a current value is unclear, measurement is performed” can be handled with a process in which measurement is performed if the gain of information amounts when measurement is performed at the current time t=0 is equal to or greater than a predetermined threshold value I_{TH}′, and measurement is not performed if the gain is smaller than the predetermined threshold value I_{TH}′.

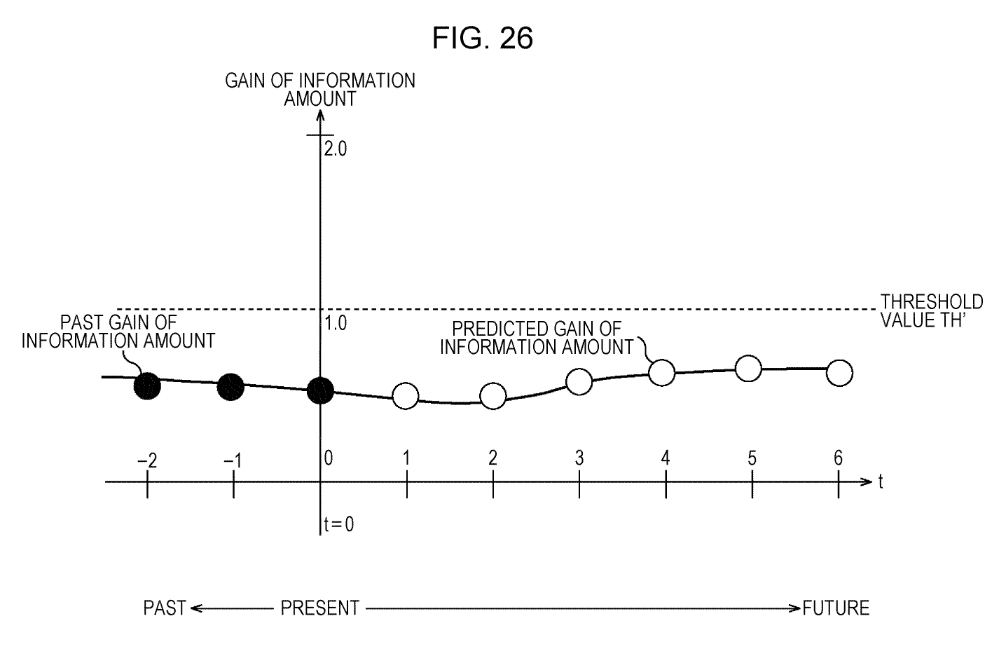

FIG. 26 is a diagram describing the request “(2) if the path to the movement destination is one road, and there is one transition between future states (states are uniformly decided), measurement is not performed” using gains of information amounts.

When the path to the movement destination is one road, states are uniformly decided, and thus, originally sufficient information amounts are acquired. Thus, gains of information amounts obtained from measurement are few. For this reason, the request “(2) if the path to the movement destination is one road, and there is one transition between future states (states are uniformly decided), measurement is not performed” is also handled with a process in which measurement is performed if a gain of information amounts when measurement is performed is equal to or higher than the predetermined threshold value I_{TH}′, and measurement is not performed if the gain is smaller than the predetermined threshold value I_{TH}′ at the future time t=1.0, 2.0, . . . .

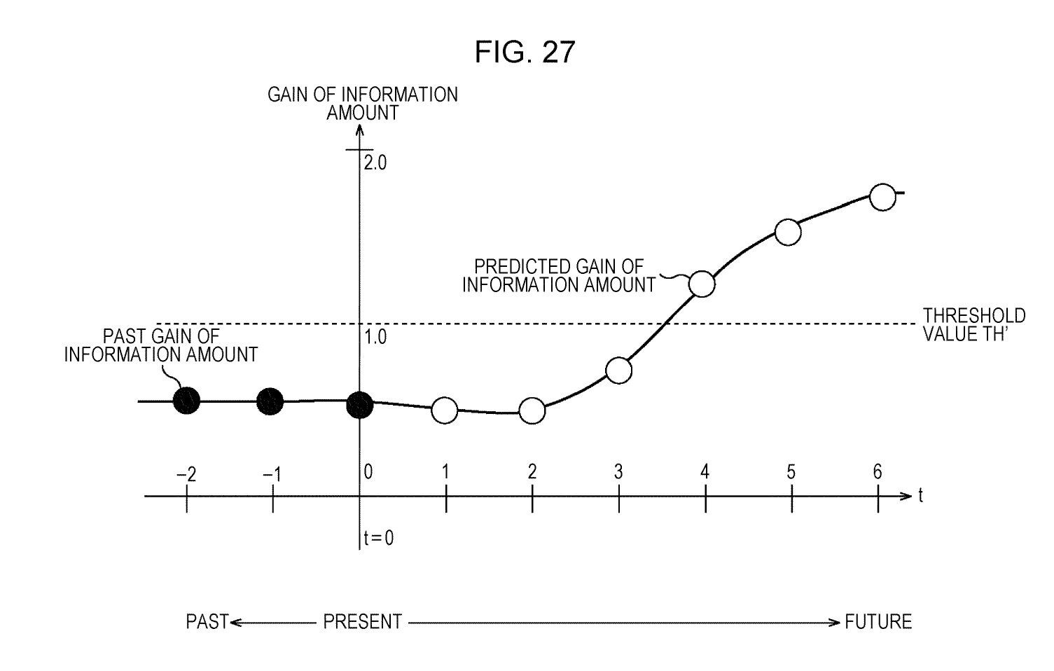

FIG. 27 is a diagram describing the request “(3) when there is a branch as a transition between future states, measurement is performed at a position past the branched point at which states are not uniformly decided” using gains of information amounts.

When there is a branch, states are uniformly decided before the branched point, but after the branched point, the states are not uniformly decided. Thus, a gain of information amounts when measurement is performed is small in a state before the branch, but the gain of the information amounts when measurement is performed is large in a state after the branch. Thus, the request “(3) when there is a branch as a transition between future states, measurement is performed at a position past the branched point can be handled with a process in which measurement is performed if the gain is equal to or higher than the predetermined threshold value I_{TH}′ and measurement is not performed if the gain is smaller than the predetermined threshold value I_{TH}′.

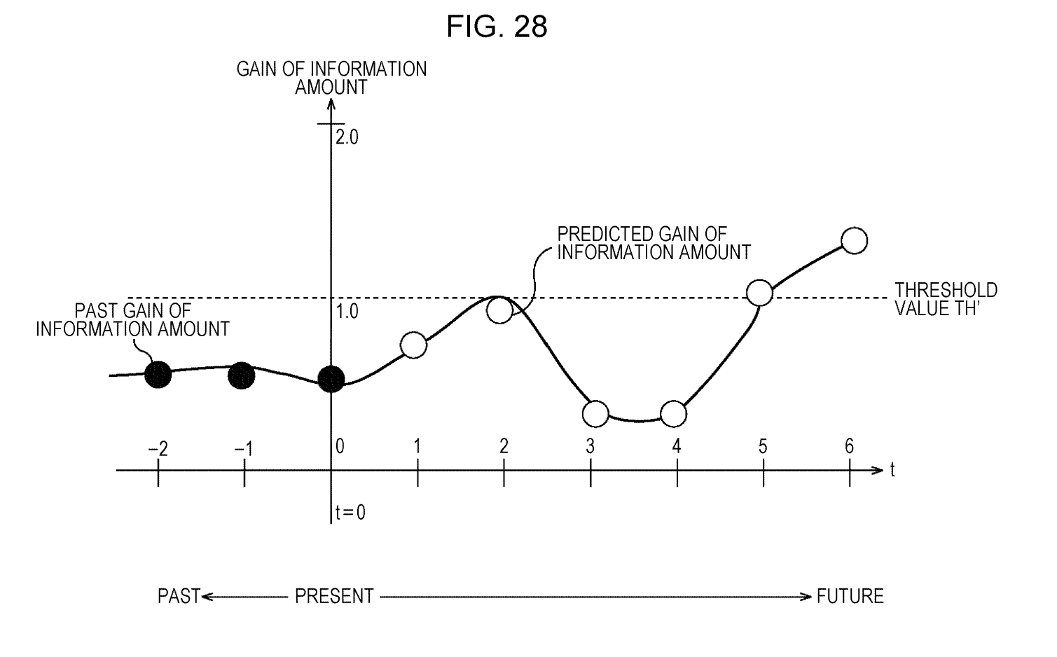

FIG. 28 is a diagram describing the request “(4) if measurement is not possible due to staying at a tunnel or a valley, measurement is not performed” using gains of information amounts.

Since measurement is not performed well when being in a tunnel or a valley, a gain of information amounts when measurement is performed becomes small. Thus, the request “(4) if measurement is not possible due to staying at a tunnel or a valley, measurement is not performed” can be handled with a process in which measurement is performed if the gain is equal to or higher than the predetermined threshold value I_{TH}′ and measurement is not performed if the gain is smaller than the predetermined threshold value I_{TH}′.

Note that, if the GPS sensor is controlled only with prediction of gains of information amounts as above, there is a problem in that measurement fails when the Hidden Markov Model (learning model) is in an unknown state. Thus, it is possible to avoid a risk of failing measurement by setting an upper limit on a sleep time such as the sleep mode is not implemented to a certain step or higher.

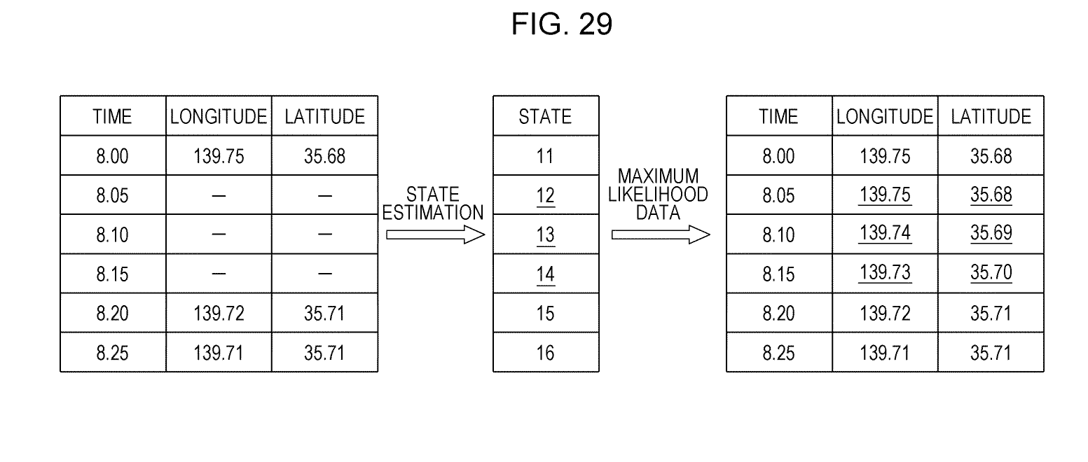

FIG. 29 shows an example of a process of restoring sparse time series data by performing continuous measurement.

In this data restoration process, a state series is first generated from sparse time series data as in the left side of FIG. 29. This generation of the state series is realize by the Viterbi algorithm as described above. Then, a missing data portion of the time series data is interpolated by selecting data of states in the generated state series corresponding to the missing portion of the time series data. In FIG. 29, the underlined numbers are data pieces restored in the data restoration process.

In the above-described examples, the example in which the sensor 14 is controlled so as to perform measurement with high efficiency considering costs incurred from the measurement as consumed power of a battery, but the present technology can be applied also to other measurement, inspection, or the like desired to perform highly efficient measurement. As application examples of the present technology, for example, defect inspection of products, medical inspection, and the like are considered. In such inspection, if inspection is performed at an equal time interval, costs of a load of inspection are certainly incurred. Thus, by computing information amounts obtained from inspection, the inspection can be controlled so as to be performed with high efficiency without performing unnecessary inspection.

Note that, in the present specification, the steps described in the flowcharts may be performed in a time series manner following the described order, in a parallel manner, or at necessary time points when there is a call-out, not necessarily performed in the time series manner.

Note that, in the present specification, a system refers to a whole system configured to include a plurality of devices.

An embodiment of the present technology is not limited to the above-described embodiments, and can be variously modified within the scope not departing from the gist of the present technology.

Note that the present technology can have the following configurations.

(1) An information processing device that includes a sensor that measures predetermined data, a model storage unit that stores a model obtained by modeling time series data measured in the past, an information amount computation unit that computes an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and a measurement control unit that controls the sensor based on the information amount obtained from the measurement.

(2) The information processing device described in (1) above, in which the model stored in the model storage unit is a Hidden Markov Model.

(3) The information processing device described in (2) above, in which the information amount when measurement by the sensor is not performed is an information amount computed from a posterior probability of state variables of the Hidden Markov Model obtained from time series data up to the previous measurement and a prior probability of state variables of a current time predicted from a transition probability of the Hidden Markov Model.

(4) The information processing device described in (2) or (3) above, in which the information amount when measurement by the sensor is performed is an information amount obtained in such a way that data obtained from measurement is expressed by an observation variable, and an expectation value of an information amount that can be computed from a posterior probability of a state variable of the Hidden Markov Model under the condition in which the observation variable is obtained is computed with respect to the observation variable.

(5) The information processing device described in (4) above, in which the information amount obtained from measurement is a mutual information amount of a state variable and an observation variable indicating a state of the Hidden Markov Model.

(6) The information processing device described in (4) or (5) above, in which, using an approximate observation variable obtained by performing maximum likelihood estimation for the state variable from the observation variable, the information amount computation unit computes the information amount obtained from measurement as a mutual information amount of the state variable and the approximate observation variable.

(7) The information processing device described in (6) above, in which the information amount computation unit is provided with a variable conversion table in which observation probabilities from which the approximate observation variable is obtained are stored for each state variable.

(8) The information processing device described in any one of (2) to (7) above, in which the model obtained by modeling the time series data has a probability that measurement succeeds or a probability that measurement fails for each state of the Hidden Markov Model as a parameter.

(9) The information processing device described in any one of (2) to (8) above, in which the model obtained by modeling the time series data further retains a state indicating an unknown state, and has a parameter for calculating a transition probability from a state of the original model to the unknown state, a transition probability from the unknown state to the original state, and a likelihood of generating an observation in the unknown state, as parameters.

(10) The information processing device described in any one of (1) to (9) above, in which the information amount computation unit determines whether or not the sensor is made to perform measurement by comparing the information amount obtained from measurement to a predetermined threshold value.

(11) The information processing device described in any one of (1) to (10) above, in which the information amount computation unit computes the information amount obtained from measurement up to a predetermined step, and based on the computation result, whether or not the sensor is made to perform measurement is determined up to the predetermined step.

(12) The information processing device described in any one of (1) to (11) above that further includes a data restoration unit that, when there is missing data in accumulated time series data that is measured by the sensor and then accumulated, estimates a maximum likelihood state series corresponding to the accumulated time series data using the model, and then restores the missing data portion of the accumulated time series data based on the estimated maximum likelihood state series.

(13) An information processing method of an information processing device that includes a sensor that measures predetermined data and a model storage unit that stores a model obtained by modeling time series data measured in the past, the method including steps of computing an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and controlling the sensor based on the information amount obtained from the measurement.

(14) A program for causing a computer of a device that includes a sensor that measures predetermined data and a model storage unit that stores a model obtained by modeling time series data measured in the past to execute processes of computing an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model, and controlling the sensor based on the information amount obtained from the measurement.

The present disclosure contains subject matter related to that disclosed in Japanese Priority Patent Application JP 2012-073504 filed in the Japan Patent Office on Mar. 28, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a sensor that measures predetermined data;
a model storage unit that stores a model obtained by modeling time series data measured in the past;
an information amount computation unit that computes an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model; and
a measurement control unit that controls the sensor based on the information amount obtained from the measurement.

2. The information processing device according to claim 1, wherein the model stored in the model storage unit is a Hidden Markov Model.

3. The information processing device according to claim 2, wherein the information amount when measurement by the sensor is not performed is an information amount computed from a posterior probability of state variables of the Hidden Markov Model obtained from time series data up to the previous measurement and a prior probability of state variables of a current time predicted from a transition probability of the Hidden Markov Model.

4. The information processing device according to claim 2, wherein the information amount when measurement by the sensor is performed is an information amount obtained in such a way that data obtained from measurement is expressed by an observation variable, and an expectation value of an information amount that can be computed from a posterior probability of a state variable of the Hidden Markov Model under the condition in which the observation variable is obtained is computed with respect to the observation variable.

5. The information processing device according to claim 4, wherein the information amount obtained from measurement is a mutual information amount of a state variable and an observation variable indicating a state of the Hidden Markov Model.

6. The information processing device according to claim 5, wherein, using an approximate observation variable obtained by performing maximum likelihood estimation for the state variable from the observation variable, the information amount computation unit computes the information amount obtained from measurement as a mutual information amount of the state variable and the approximate observation variable.

7. The information processing device according to claim 6, wherein the information amount computation unit is provided with a variable conversion table in which observation probabilities from which the approximate observation variable is obtained are stored for each state variable.

8. The information processing device according to claim 2, wherein the model obtained by modeling the time series data has a probability that measurement succeeds or a probability that measurement fails for each state of the Hidden Markov Model as a parameter.

9. The information processing device according to claim 2, wherein the model obtained by modeling the time series data further retains a state indicating an unknown state, and has a parameter for calculating a transition probability from a state of the original model to the unknown state, a transition probability from the unknown state to the original state, and a likelihood of generating an observation in the unknown state, as parameters.

10. The information processing device according to claim 1, wherein the information amount computation unit determines whether or not the sensor is made to perform measurement by comparing the information amount obtained from measurement to a predetermined threshold value.

11. The information processing device according to claim 1, wherein the information amount computation unit computes the information amount obtained from measurement up to a predetermined step, and based on the computation result, whether or not the sensor is made to perform measurement is determined up to the predetermined step.

12. The information processing device according to claim 1, further comprising:
a data restoration unit that, when there is missing data in accumulated time series data that is measured by the sensor and then accumulated, estimates a maximum likelihood state series corresponding to the accumulated time series data using the model, and then restores the missing data portion of the accumulated time series data based on the estimated maximum likelihood state series.

13. An information processing method of an information processing device that includes a sensor that measures predetermined data and a model storage unit that stores a model obtained by modeling time series data measured in the past, the method comprising:
computing an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model; and
controlling the sensor based on the information amount obtained from the measurement.

14. A program for causing a computer device that includes a sensor that measures predetermined data and a model storage unit that stores a model obtained by modeling time series data measured in the past to execute:
computing an information amount obtained from measurement based on the difference of an information amount when measurement by the sensor is not performed which is decided based on a prior distribution of state variables of the model and an information amount when measurement by the sensor is performed which is decided based on a posterior distribution of the state variables of the model; and
controlling the sensor based on the information amount obtained from the measurement.
